(19) United States
(12) Patent Application Publication
(10) Pub. No.: US 2024/0268279 A1
(43) Pub. Date: Aug. 15, 2024

(54) INCREASING GREENHOUSE PRODUCTION BY SPECTRAL-SHIFTING AND UNIDIRECTIONAL LIGHT-EXTRACTING PHOTONICS

(71) Applicant: THE REGENTS OF THE UNIVERSITY OF COLORADO, A BODY CORPORATE, Denver, CO (US)

(72) Inventors: Ronggui YANG, Boulder, CO (US); Xiaobo YIN, Boulder, CO (US); Lihua SHEN, Idaho Falls, ID (US)

(21) Appl. No.: 18/569,171

(22) PCT Filed: Jun. 17, 2022
(86) PCT No.: PCT/US2022/034031

§ 371 Date: Dec. 11, 2023

Related U.S. Application Data
(60) Provisional application No. 63/212,598, filed on Jun. 18, 2021.

(51) Int. Cl. A01G 7/06; A01G 9/14; G02B 1/04; G02B 3/00

(52) U.S. Cl. CPC A01G 7/06; A01G 9/14; G02B 1/041; G02B 3/0037

(57) ABSTRACT

Improving photosynthesis and light capture increases crop yield and paves a sustainable way to meet the growing global food demand. A spectral-shifting microphotonic film is provided particularly for applications to improved plant growth, for example, as a greenhouse envelope. The spectral-shifting microphotonic film can be scalable manufactured for augmented photosynthesis. By breaking the intrinsic propagation symmetry of light, the photonic microstructures provided in the film can extract 89% of the internally generated light and deliver most of that into one direction towards photosynthetic organisms. The microphotonic film augments crop production (e.g., lettuce) by more than 20% in both indoor facilities with electric lighting and in a greenhouse with natural sunlight, providing a way to increase crop production efficiency in controlled environments.

### CROSS-REFERENCE TO RELATED APPLICATIONS

This application claims the benefit of U.S. Provisional Application 63/212,598, filed Jun. 18, 2021, which application is incorporated by reference herein in its entirety.

### STATEMENT REGARDING FEDERALLY SPONSORED RESEARCH OR DEVELOPMENT

This invention was made with government support under grant number 2018 67003-27407 awarded by the Department of Agriculture. The government has certain rights in the invention.

### BACKGROUND OF THE INVENTION

Managing light quantity (photon flux density, PFD) and quality (photon spectrum) for photosynthesis provides a secure venue for improving crop yield (1, 2) but comes with costs. For example, increasingly-adopted horticultural lighting (3, 4) consumed nearly 6 TWh of electricity in 2017 in the United States alone (5). Herein a passive approach to increase the production of crops in different growth environments is provided. The approach involves improving the photosynthetic photon spectrum using a spectral-shifting and unidirectional light-extracting photonic thin film. The micro-photonic film as described herein allows harvesting of 20% more aboveground biomass of leafy green lettuce indoors in regulated growth compartments with broad spectrum grow lights or outdoors in a greenhouse facility with natural sunlight. The photonic films can, as we demonstrate experimentally, serve as greenhouse envelopes to provide more effective photosynthetic light than that of direct sunlight, opening the door for “red-colored” greenhouses with substantially augmented yields.

Not every spectral component of sunlight contributes equally to photosynthesis (6). Extracted and purified chlorophyll a and b, the primary molecular pigments in plants and other photosynthetic organisms, absorb strongly in the blue (400-500 nm) and red (600-700 nm) portions of sunlight (FIG. 1A), with red light being the most effective for photosynthesis (8). Greater reflection of green light (500-600 nm) is why leaves and most photosynthetic organisms appear green, for example, as shown by the averaged absorbance spectra of leaves from a 20-day-old leafy green lettuce (FIG. 1A). Exploiting a spectral-shifting material to convert the green component of sunlight, which accounts for 35% of its photosynthetically active radiation (PAR) (400-700 nm), to more photosynthetically active red light (wavelengths ˜620 to 750 nm) should have greater potential for promoting photosynthesis (FIG. 1B) (7-10). However, the concept of passive augmentation of photosynthesis is hindered by a simple, but fundamental, optics challenge: when a material is emissive, the majority of the internally generated photons is trapped inside the material, leading to seemingly encouraging, but inconsistent, results (11-15). Emerging optical systems, such as highly efficient photovoltaics (12-13) and luminescent concentrators (14), take advantage of the trapped light for improving light-to-electricity conversions, but the trapping effect adversely constrains the efficiency of light-emitting devices (15) due to limited light extractions.

Numerous photonic structures have been developed to suppress the trapping and extract light for external use, yet all efficient light extraction structures reported to date rely critically on omnidirectional back reflectors (16) which are opaque and hinder their uses as greenhouse envelopes. The present disclosure provides a reflector-free, spectral-shifting micro-photonic thin film that can be scalable manufactured for augmented photosynthesis. More importantly, by breaking the intrinsic propagation symmetry of light, photonic microstructures are introduced to extract 89% of the internally generated light and deliver most of that light into one direction towards photosynthetic organisms. In stark contrast, in an otherwise planar film, maximally 13% of the internally generated light can be utilized in a greenhouse setting.

### SUMMARY

The disclosure provides a spectral-shifting and unidirectional light extracting film, sheet or layer which comprises a matrix having a spectral-shifting material or spectral-shifting compound distributed therein, wherein the film, sheet or layer also comprises a surface structure that functions for unidirectional light extraction. The film, sheet or layer of the disclosure is reflector-free and does not rely upon omnidirectional back reflectors. In an embodiment, the spectral-shifting material or spectral-shifting compound is uniformly distributed in the matrix of the film, sheet or layer. In embodiments, the matrix is a polymeric or polymer matrix which is substantial transparent to light wavelengths useful in a selected application. Substantially transparent as used herein means at least 10% transparent at a wavelength in the useful wavelength range. Preferably, the matrix is greater than 50% transparent or greater than 80% transparent at a wavelength in the useful range. It is noted that the film or sheet should be substantially transparent to wavelengths from a source of illumination to facilitate entry into the film, sheet or layer, as well as substantially transparent to the shifted wavelengths to facilitate exit from the film, sheet or layer.

In general, the polymer is any polymer that is substantial transparent as described herein and which has appropriate mechanical properties for its selected use. In embodiments, the polymer matrix is supported on a substrate to provide appropriate mechanical properties for its use. In embodiments, the polymer is selected from poly(methyl methacrylate), polyethylene (including high density polyethylene (HDPE) or low density polyethylene (LDPE), an acrylic polymer, polyethylene terephthalate (including, among others, biaxially-oriented polyethylene terephthalate), polyvinylidene fluoride, ethylene tetrafluoroethylene, polycarbonate, cellulose acetate and mixtures thereof.

In embodiments, the spectral-shifting and unidirectional light extracting film, sheet or layer is prepared by introducing a spectral-shifting material or spectral-shifting compound into a solid matrix and distributing the material or compound therein. In embodiments, a spectral-shifting and unidirectional light extracting film, sheet or layer is prepared by coating a solid with a layer of film comprising a spectral-shifting material or spectral-shifting compound in a coating or in a polymer matrix. The solid is preferably substantial transparent to light of wavelengths useful in a selected application and into which the spectral-shifting material or compound can be introduced and distributed.

The spectral-shifting material or spectral-shifting compound is selected to achieve the desired spectral shift for a given application. In embodiments, the spectral-shifting material or spectral-shifting compound is a molecular dye, a quantum dot or a phosphorous compound. In embodiments, the spectral-shifting material or spectral-shifting compound is a quantum dot. In embodiments, the spectral-shifting material or spectral-shifting compound is a perylene-based fluorescent dye and in a more specific embodiment is LF305. In embodiments, the spectral-shifting material or spectral-shifting compound is a rare earth complex. In embodiments, the material or compound is an organic phosphor.

In embodiments, the spectral-shifting and unidirectional light extracting sheet or film comprises two or more layers. In embodiments, a surface layer of the film or sheet is provided with a surface structure. In embodiments, the spectral-shifting material or spectral-shifting compound is in a separate layer different than the surface layer which comprises the surface structure. In embodiment, a single layer comprises the spectral-shifting material or spectral-shifting compound and surface structure.

In embodiments, the film or sheet has a top surface through which light enters and a bottom surface through which light exits. In embodiments, the surface structure is formed on the top surface of the sheet or film. In embodiments, the surface structure is formed on the bottom surface. In embodiments, a surface structure is formed on both the top and the bottom surface of the sheet, film or layer.

In embodiments, the surface structure has at least one dimension that is microscaled ranging from about 1 micron to about 1000 microns. In embodiments, the surface structure has at least one dimension that ranges from about 5 micron to about 1000 microns. In embodiments, the surface structure has at least one dimension that ranges from about 5 micron to about 500 microns.

In general, any surface structure, periodic or random, which provides for unidirectional extraction of the shifted wavelengths from the sheet, film or layer can be used. Methods for designing such structures and optimizing such structures for given materials, matrix materials, spectral-shifting materials and compounds and the shifted spectrum that is useful for a given application are described in the examples herein. These methods can be readily adapted by those of ordinary skill in the art to materials and ns spectral shifts different from those specifically described herein.

In embodiments, the surface structure is an array of micro-domes having a height and a pitch as described herein. A microdome is a structure derived from a section cut through a sphere. In embodiments, the microdome is a hemisphere. It is noted that the shape of the microdome may deviate from a smooth spherical surface without loss of unidirectional light extracting function. In embodiments, a microdome has a height ranging from about 50 to about 100 microns, or 25 to 200 microns, or 50 to 85 microns. In embodiments, a microdome has a period of 300 to 500 microns, or 100 to 500 microns, or 250 to 300 microns. In embodiments, the array of microdomes is close-packed.

In embodiments, the sheet or film has a thickness ranging from 5 microns up to 10 millimeters. In embodiments, the sheet or film has a thickness ranging from 5 micron to 500 micron or from 20 micron to 500 micron, or from 20 micron to 300 micron, or from 100 micron to 300 micron.

In embodiments, the sheet or film may be mounted on a substrate, such as a greenhouse window.

The disclosure also provides a method for delivering a selected shifted wavelength range to a selected location from a source of illumination which comprises positioning a sheet or film as described herein between the source and the delivery location such that light from the source passes through the thickness of the sheet or film. In general the source of illumination is any source which it is desired to wavelength shift. The source of illumination can be natural sunlight, filtered sunlight, artificial sunlight or artificial light. In embodiments, the delivery location is into a greenhouse or any related enclosure for growing plants. In embodiments, the delivery location is to plantings, seedlings or growing plants.

More specifically, the disclosure provides, a method for enhancing the growth of a seed, seedling or plant which comprises delivery of a selected shifted wavelength range suitable for growth enhancement of the seed, seedling or plant to a location containing the seed, seedling or plant, wherein a sheet or film as described herein is positioned between the source of illumination and the delivery location and where the spectral-shifting material or spectral-shifting compound in the matrix of the sheet or film is selected to provide the selected shifted wavelength range. In embodiments, the delivery location is plantings, seedlings or growing plants in a greenhouse or other plant growth structure. In embodiments, the source of illumination is natural sunlight.

The disclosure also provides a greenhouse or related plant grown structure wherein the sheet or film covers at least a portion of the windows in the greenhouse.

Other aspects and embodiments of this disclosure will be apparent to one of ordinary skill in the art on review of the non-limiting description, drawings and examples herein.

### BRIEF DESCRIPTION OF THE DRAWINGS

FIGS. 1A-1H. Increasing photosynthesis with a spectral-shifting and unidirectional light-extracting film. FIG. 1A shows the normalized absorbance spectra of extracted and purified chlorophyll a (1) and b (2). The averaged absorbance spectrum from leaves of a 20-day-old leafy green lettuce (3) is also plotted for comparison. FIG. 1B, shows the spectrum of the Air Mass 1.5 solar spectral irradiance (AMI 0.5) between 400 to 750 nm. Spectral conversion of green light (500-600 nm, amounting to 35% of the total PAR photons) to more photosynthetically active red light can promote photosynthesis. FIG. 1C is a schematic diagram of use of a spectral-shifting and unidirectional light-extracting film in a greenhouse setting for enhancing photosynthesis. FIGS. 1D and 1E are schematic side views of a planar film (FIG. 1D) and a unidirectional light-extracting film (FIG. 1E) with surface microdome structures, respectively. Rays A. B. and C illustrate three light trajectories with incident angles larger than the critical angle (θ_{c}), which would have been trapped in the planar film, being extracted in the forward direction because of total internal reflections at the curved surface of the micro-dome structures. FIG. 1F illustrates surface topography of the exemplary surface micro-dome structures measured by an optical profilometer (NT3300, Veeco/Wyko). FIG. 1G shows the forward spectral irradiance of the unidirectional light-extracting film (4), fluorescent film without surface structures (1), planar fluorophore-free film (2), and fluorophore-free film with surface structures (3) under the emulated solar irradiance. Simulations based on a Monte Carlo ray-tracing method on the same films are also shown (open circles) for comparison. The spectral irradiance was normalized to AMI 0.5 and the ray-tracing data were down-sampled for visual clarity of the plots. FIG. 1H shows total external quantum efficiency (EQE) and the forward EQE of the unidirectional light-extracting film at various angles of incidence.

FIGS. 2A-2E. Productivity of indoor-grown lettuce plants. FIG. 2A is a graph of recorded DLI at plant canopy level under the fluorophore-free films (control) and the light-extracting films (experiment). FIGS. 2B-E. Graphs of aboveground fresh weight (FIG. 2B), dry weight (FIG. 2C), average leaf area (FIG. 2D) and SPAD value (FIG. 2E) of lettuce at day 23 after transplant under the control (CON) and experimental (EXP) films with two PAR levels LOW and HIGH). Data are means±SD. Asterisks indicate statistically significant differences between experiment and control groups in each of three experimental replications (1, 2 and 3), as determined by Student's t-test (*, P<0.05; **, P<0.01 and ***, P<0.001).

FIGS. 3A-B. Photosynthetic CO₂ assimilation of a whole lettuce plant in a closed chamber. FIG. 3A is a graph of average CO₂ concentration change in a closed chamber with a 14-day-old lettuce plant. The fluorophore-free film (control) and the unidirectional light-extracting film (experiment) were examined, respectively. For comparison, the films were covered on top of the chamber at time zero when the light is on. In all cases, an identical impinging photosynthetic photon flux density (PPFD) of ˜400 μmol·m⁻²-s⁻¹ was used (measured right above the films). Data are means±SD. FIG. 3B is a graph of CO₂ fixation rate of the 14-day-old lettuce plant under the fluorophore-free film (control) and the unidirectional light-extracting film (experiment). The data was smoothed by the Savitzky Golay method. Data are means±SD. Asterisk indicates significant difference (*, P<0.05).

FIGS. 4A-4F. Productivity of ‘Buttercrunch’ lettuce in a greenhouse with natural sunlight. Semicylindrical roof domes were arranged in a greenhouse facility. Two domes had spectral-shifting, unidirectional light-extracting films installed (experiment) and two others had fluorophore-free films (control). FIG. 4A is a graph of daily average, maximum, and minimum temperatures in all four domes over time (July-August). FIG. 4B is a graph of DLI inside the control and experimental dome over the same time period (July-August). FIGS. 4C and 4D are graphs of aboveground fresh weight (FW) and dry weight (DW) of the lettuce, respectively, at day 20 after transplantation (two replicates). FIGS. 4E and 4F are graphs of average leaf area and SPAD values, respectively, of the lettuces at day 20 after transplantation (two replicates). Data are means±SD. Asterisks indicate statistically significant differences between experiment and control groups in each replication (*, P<0.05: **, P<0.01: ***, P<0.001).

FIG. 5. Geometry of a fluorescent film. Schematic illustration. Incoming sunlight (top surface arrows) enters the film and is partially absorbed by fluorophores (dots). Part of the emission falls within the escape cone (52) and exits the film from the top (1) or bottom (2) surfaces. The other part of the emission (3) is trapped inside the film due to total internal reflections. The schematic is not drawn to scale.

FIG. 6. The normalized absorption and emission spectra of Lumogen F Red 305 (LF305, BASF, Germany) with the overlapped region shaded. The wavelength of absorption peak (and emission peak (2.1) are indicated by dashed lines.

FIGS. 7A-7B Monte Carlo ray tracing of a unidirectional light-extracting film. FIG. 7A is a cross-sectional schematic of the unidirectional light-extracting film with microdome structures. Fluorophores are indicated by dots. The x and z coordinate directions are shown. FIG. 7B is a visualization of ray trajectories in the unidirectional light-extracting film. The forward viewing direction is along the z-axis. For the purpose of visual clarity, only 9 (3×3) microdomes were used and 1,000 rays were traced. The film and the microdomes are indicated at 1. The x and y coordinate directions are shown. The schematic is not drawn to scale.

FIGS. 8A-8C Light-extracting effect of a planar fluorescent film and a unidirectional light-extracting film. Escape light cone of the planar fluorescent film and the unidirectional light-extracting film are shown in FIG. 8A and FIG. 8B, respectively. Fluorophores are indicated by red dots. The schematic is not drawn to scale. FIG. 8C shows the corresponding spectral irradiance of the planar fluorescent film (top) and the unidirectional light-extracting film (bottom). Backward (1), forward (2) and trapped (3) light is illustrated as a function of wavelength. The spectral irradiance was normalized to AM1.5.

FIG. 9. Blade-coating of unidirectional light-extracting film. Schematic illustration of blade coating process using a precisely manufactured polyether ether ketone (PEEK) replica mold with inverse structures (e.g., of microdomes) in an area of 150 mm×240) mm.

FIG. 10 Experimental results of the forward spectral irradiance from the unidirectional light-extracting film compared with the planar fluorescent film. The shaded regions between curve 4 and curve 2 and curve 1 and curve 2 (right in graph) represent the number of emitted photons in the forward direction ΦExp/Forward collected by an integrating sphere from a planar fluorescent film and light-extracting film respectively, and the shaded region between curve 2 and curves 1 and 4 (left in graph) represents the number of photons being absorbed (ΦAbs).

FIGS. 11A and 11B. Transmittance and reflectance of greenhouse envelopes. FIG. 11A shows transmittance and reflectance of the fluorophore-free film with light-extracting structures (dashed lines) and the fluorophore-free planar film (solid lines). The inset shows the angle of incidence. The data points were simulated by the Monte Carlo ray-tracing method. The solid curves were computed by the Fresnel Equations for planar film and the dashed curves were fitted to the simulated data for the film with surface structures. FIG. 11B shows angular spectra of the transmittance, reflectance, and absorption of the LF305-doped unidirectional light-extracting film. The x-axis is the same in FIGS. 11A and 11B.

FIGS. 12A-C. Solar angle and its impact on the photosynthetic photon flux density (PPFD) inside domes covered with the light-extracting film as greenhouse envelopes. FIG. 12A is a graph of PPFD under the unidirectional light-extracting film (1) and the fluorophore-free film (2) with surface microstructures over the course of a day. FIG. 12B is a plot of the corresponding ratio (%) of the PPFD under the unidirectional light-extracting film to that of the fluorophore-free film with surface microstructures. FIG. 12C is a graph of impinging solar irradiance in time over a day monitored by a commercial weather station (WS-1000-WiFi; Ambient Weather, Chandler, Arizona, USA). The x-axis in all three figures is the same.

FIGS. 13A and 13B. Photostability of the unidirectional light-extracting films. The forward spectral irradiance of the unidirectional light-extracting film is shown in FIG. 13A at Day 1, Day 40, and Day 120 upon outdoor exposure under natural sunlight. The spectral irradiance was normalized to AM1.5. The corresponding photon flux density (PFD) is shown in FIG. 13B at 565 nm (peak absorbance wavelength). 640 nm (peak emission wavelength), and 750 nm, respectively.

FIG. 14. Spectral irradiance from various light sources. Spectral irradiance of AM1.5 (1), solar simulator (2) and broad-spectrum LEDs (3) in the range of 400-800 nm. The LEDs show a similar spectral irradiance as the sunlight for most of the photosynthetically active radiation (PAR) waveband.

FIG. 15. Spectral distribution. Spectral distribution was measured directly above (1) and below (3) the fluorophore-free film, and directly below the spectral-shifting, unidirectional light-extracting film (2) illuminated by white LEDs (High CRI 95. Active Grow Inc., Seattle, WA).

FIGS. 16A and 16B. Light intensity distribution under LEDs. FIG. 16A shows a schematic of the lighting of indoor lettuce grown under LEDs (4 tubes), corresponding to the case of high PAR level. 10 lettuce plants were evenly distributed along the x and y axis. The PPFD was measured by a PAR quantum meter (MQ-501. Apogee Instruments, Inc., USA) at different heights. FIG. 16B is a graph of light intensity distributions in vertical directions under the fluorophore-free film (control, open diamonds) and the spectrum-shifting, unidirectional light-extracting film (experimental, open circles). For comparison, the impinging PPFD of 500 μmol·m-2·s-1, measured directly above the films, is highlighted by a black solid star.

FIG. 17. Absorbance spectra of green leaves in ‘Buttercrunch’ lettuces. Normalized absorbance spectra for a 10-day-old and a 20-day-old lettuce plant. The spectra were averaged from the normalized absorbance spectra of all leaves in the two plants, respectively.

FIG. 18. Spectral characteristics of the plastic filters. Transmission of a yellow long-pass filter with a cut-off wavelength at 492 nm (010) Medium Yellow, LEE Filters, CA, USA) and a blue band-pass filter with a long wavelength cut-off at 495 nm (721 Berry Blue, LEE Filters, CA, USA).

FIGS. 19A-D. Indoor lettuce growth with modulated blue light intensities. FIG. 19A shows the spectral distributions at canopy level under different treatments. Treatments are: spectral-shifting, unidirectional light-extracting film with nearly no blue light (Film w/o Blue) (when the LED tubes were fully wrapped with the yellow LEE long-pass filters): spectral-shifting, unidirectional light-extracting film with reduced (−) blue light (Film-Blue) (when the LED tubes were partially wrapped with the yellow LEE long-pass filters); spectral-shifting, unidirectional light-extracting film (Film); and spectral-shifting, unidirectional light-extracting film with supplementary (+) blue light (Film+Blue). FIG. 19B is a graph of average daily light integral (DLI) at plant canopy level under different treatments. FIGS. 19C and 19D are graphs of aboveground fresh weight and dry weight, respectively, of ‘Buttercrunch’ lettuces at day 16 after transplantation under different treatments. Treatments are from left to right in each of FIGS. 19B-D: Film w/o Blue, Film−Blue, Film, and Film+Blue. Data are means±SD. Values with the same letter are not statistically different at P=0.05.

FIGS. 20A-20D. Comparative growth study of ‘Buttercrunch’ lettuce outdoors under the semicylindrical domes. FIG. 20A shows the daily maximum, minimum, and average temperature in all four domes. FIG. 20B is a histogram of the average temperature under the control and experiment throughout the entire growth period. FIG. 20C shows DLI in all four domes. FIG. 20D shows total light integral during the entire growth period (17 days) under the control and experiment.

### DETAILED DESCRIPTION

### Spectral-Shifting and Unidirectional Light-Extracting Optics

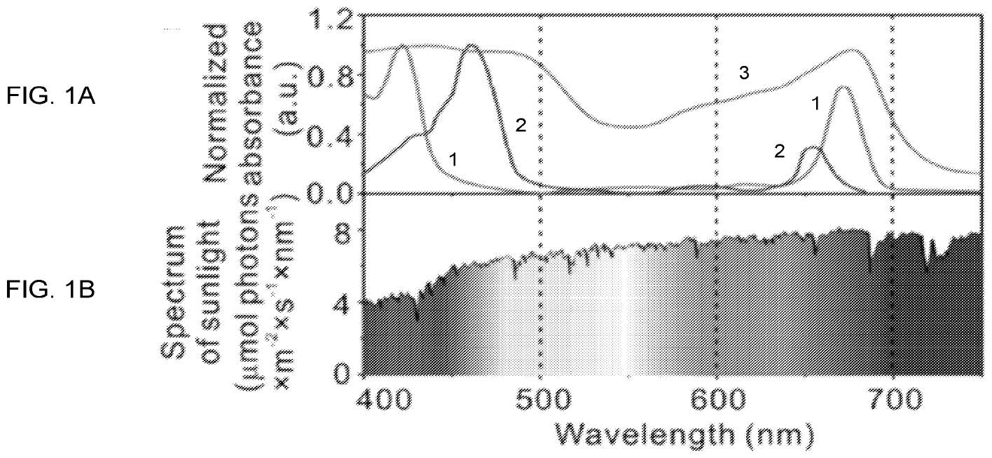

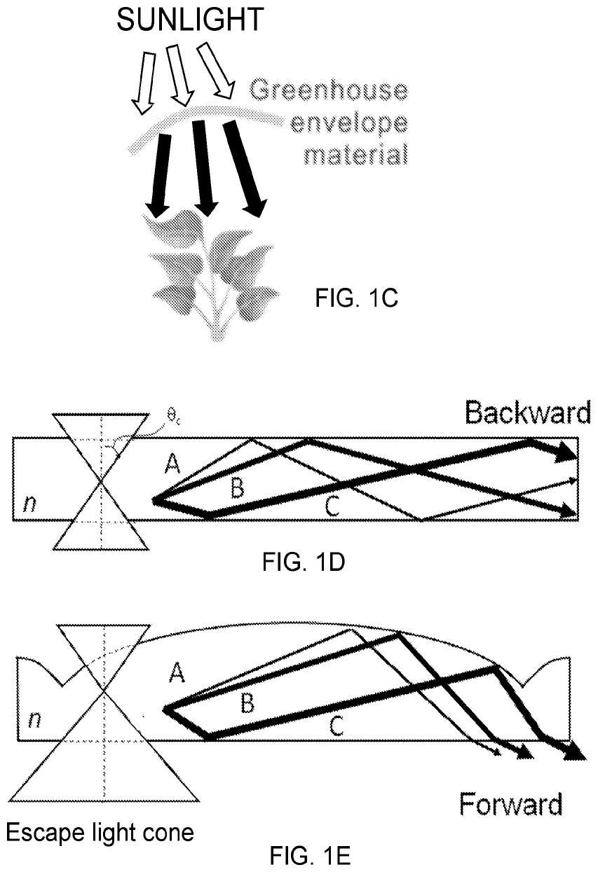

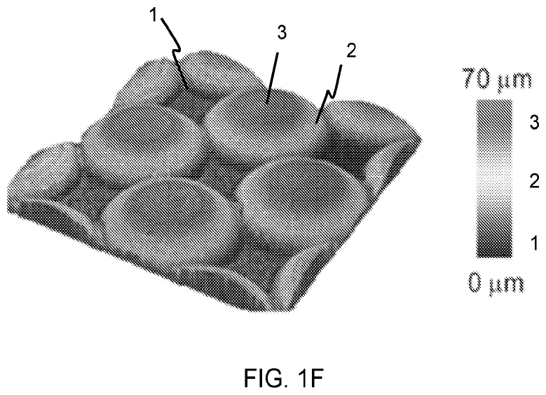

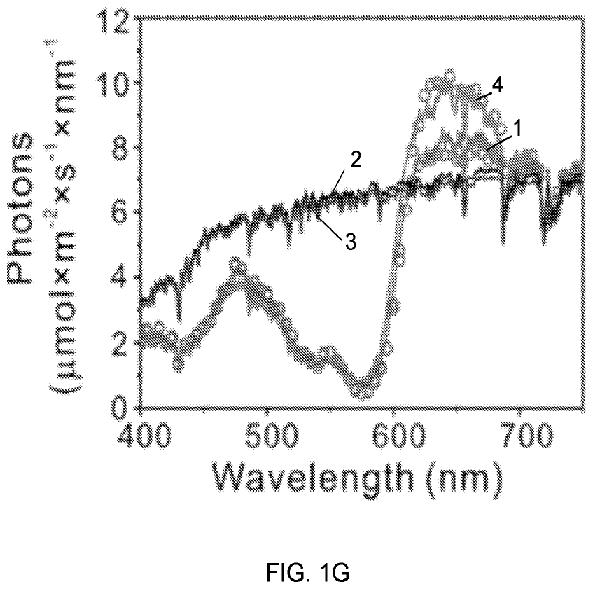

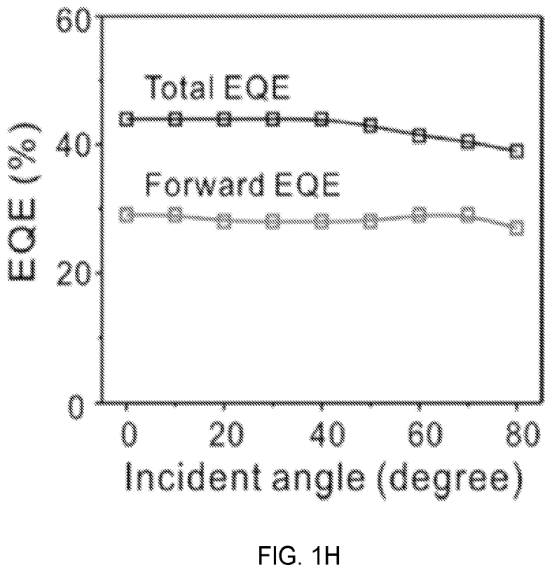

Plants and other photosynthetic organisms, absorb strongly in the blue (400-500 nm) and red (600-700 nm) portions of sunlight (FIG. 1A), with red light being the most effective for photosynthesis. Greater reflection of green light (500-600 nm) is why leaves and most photosynthetic organisms appear green, for example, as shown by the averaged absorbance spectra of leaves from a 20-day-old leafy green lettuce (FIG. 1A). Exploiting a spectral-shifting material (including a spectral-shifting compound) to convert the green component of sunlight to more photosynthetically active red light (wavelengths ˜620 to 750 nm) has greater potential for promoting photosynthesis (FIG. 1B). FIG. 1C schematically illustrates using a greenhouse envelope for passive augmentation of photosynthesis with no supplemental electric lighting. The film converts the impinging sunlight (or other useful light source, such as grow lights) to a photon spectrum that more effectively drives the production of photosynthetic organisms underneath. To make the film effective for augmented photosynthesis, three key processes are addressed: the internal quantum efficiency of spectral converters (spectral-shifting material or spectral-shifting compound) must be close to unity: a high fraction of the internally generated photons must be extracted in one direction (unidirectionally extracted) towards photosynthetic organisms; and the attenuation of internally generated photons, as they travel out of the material, should be minimized (i.e., a low self-absorption). These three processes contribute to the overall external quantum efficiency in the forward direction (n_{EQE}^{forward}), where the forward direction is towards the plants (or other objects being illuminated).

For a planar film of spectral-shifting materials, as illustrated by the multiple light trajectories in FIG. 1D, total internal reflections limit the number of internally generated photons that can exit the film from the escape light cone into free space. Assuming there is no self-absorption, the maximum light extraction efficiency is η_{extraction}=1−\sqrt{1−1/n²}˜25% (i.e., less than 13% equally out of each side of the planar film) and ˜75% of the spectrally shifted light is trapped in the film. In this assessment, the spectral-shifting material is assumed to be optically uniform, isotropic and to have an index of refraction of n=1.5.

To extract the trapped photons unidirectionally towards plants using light-extracting photonics, the key is to recycle the originally trapped photons and selectively redirect them back into the forward escape cone (17-20) Taking advantage of the conservation of optical etendue, the product of emitting area and solid angle (18, 22) asymmetrically corrugated interfaces are introduced to break the propagation symmetry of the internally generated light for unidirectional light extraction. As schematically illustrated by the multiple light trajectories in FIG. 1E, a micro-dome array on the top surface (the surface opposite the surface from which light is intended to escape) increases the surface area, but narrows the angular distribution of internally reflected light, recycling the otherwise trapped light with large incidence angles by redirecting it into the forward light cone.

FIG. 1F shows the surface topography of the fabricated micro-dome structures, which are closely packed on a square lattice with a period of 400 μm and a height of 65 μm. In a micro-structured film with 225,000 micro-domes patterned in an area of 150 mm×240 mm, the strong light extraction effect can be readily recognized visually under green light illumination by the brightness of the central region compared to that of the surrounding areas having no structures fabricated (see FIG. 1g in Shen et al., 2021). More importantly, the light extractions are highly asymmetric in the forward and backward viewing directions (see FIGS. h and i in Shen et al., 2021), indicating unidirectional propagations of the spectrally-shifted light.

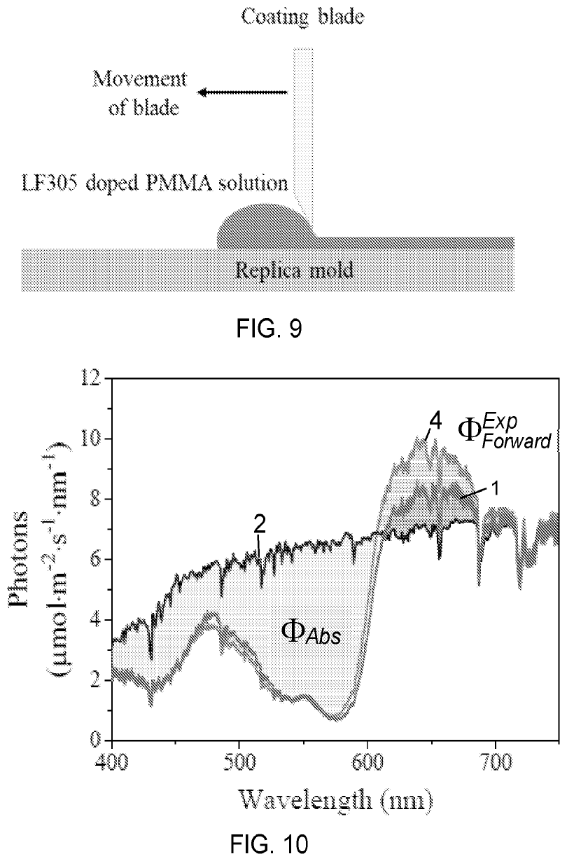

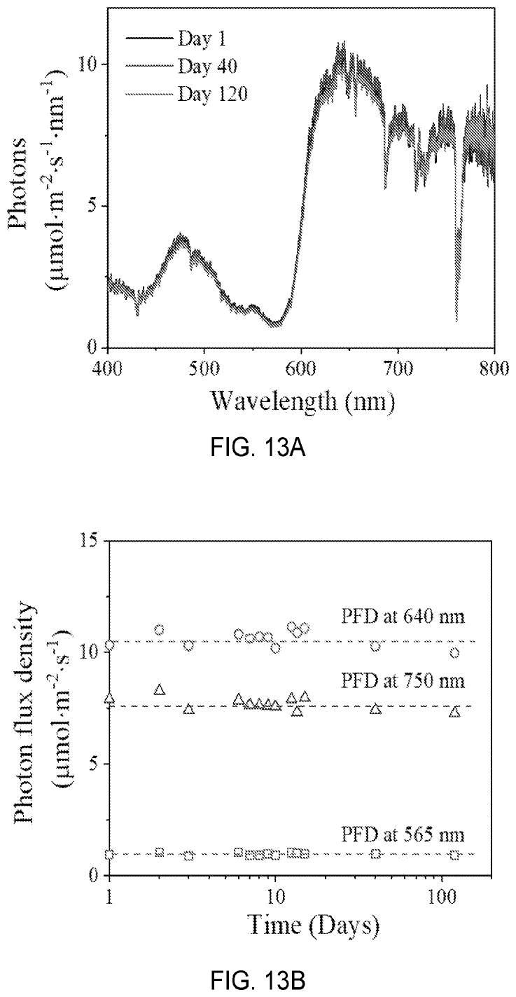

An exemplary film was batch-processed via blade coating using a precisely manufactured polyether ether ketone (PEEK) replica mold (FIG. 9). A variety of hosting matrices and spectral converters including molecular dyes and phosphorus materials were examined for high efficiency spectral shifting and light extraction. An exemplary film made of poly(methyl methacrylate) (PMMA) containing 0.1 wt. % of Lumogen F Red 305 (LF305. BASF. Germany) was prepared. N, N-dimethylformamide (DMF) was used as the solvent during the blade coating and replica molding (see Examples/methods). The perylene-based fluorescent dye, LF305 has a high internal quantum efficiency and, more importantly, is photo-stable in electrically inert matrix materials (FIGS. 13A and B) and can be processed in a variety of solvents including DMF. In general, any method known in the art can be employed for preparation of a film of the thickness described herein that allows the introduction of the film surface structures that function for unidirectional light extraction.

The emission spectrum of LF305 overlaps well with the absorption spectra of leafy green lettuce, a model organism as discussed in later sections, which effectively promotes its biomass production. FIG. 1G shows the forward spectral irradiance of this exemplary spectral-shifting, unidirectional light-extracting film (4) under an emulated one-sun AM1.5 irradiation (91192A Solar simulator. Newport Inc.) using a spectroscopic integrating sphere (IS200-4. Thorlabs Inc.). Three types of control samples, including a planar fluorophore-free film (1), a planar fluorescent film (2), and a fluorophore-free film with micro-dome structures (3), all having the same effective thickness and containing the same amounts of fluorophores, were studied for comparison. The fluorescent films, irrespective of the presence of the structures, absorb strongly in the green portion of the spectrum and re-emit in the red, resulting in higher red irradiance than that of the fluorophore-free films. Remarkably, the unidirectional light-extracting film (4) shows a substantially increased forward irradiance of the red light. The light-extracting structures diffuse the transmitted light but, as shown in FIG. 1G, do not change the overall transmittance of the externally incident sunlight: it has nearly the same transmittance as that of the planar fluorophore-free films.

The performance of the unidirectional light-extracting optical films can be fully predicted using the Monte Carlo ray-tracing method (19, 20). The surface structure shown in FIG. 1F was designed and optimized by this method. With the assumption that the fluorophores are homogeneously and isotropically distributed, all physical processes including spectral-shifting and self-absorptions of fluorophores were captured in the model. The excellent agreement between theory (simulations shown as open circles) and experiment in FIG. 1G allows extraction of the internal quantum efficiency, η_{QE}˜90% for LF305 hosted in PMMA (21) and the total external quantum efficiency. η_{EQE}˜43.8% (see: Table 1). The exemplary unidirectional light-extracting film has a high η_{extraction} of up to ˜89% and more importantly, 73% of the externally extracted light is re-directed in the forward direction and can be used to increase photosynthesis. In contrast. LF305 doped films without unidirectional light-extracting structures only provide 9% of the internally generated light in the forward direction. The total external quantum efficiency, η_{EQE}, and the external quantum efficiency in the forward direction, η_{EQE}^{forward}, are weakly sensitive to the incident angle (FIG. 1H). The surface micro-structures allow slightly more light to be in-coupled than that of a planar film at large incident angles. This makes the unidirectional light-extracting films particularly suitable for outdoor uses where solar altitude angle varies throughout the day.

Increased Lettuce Production in Controlled Indoor Environment with LED Lighting

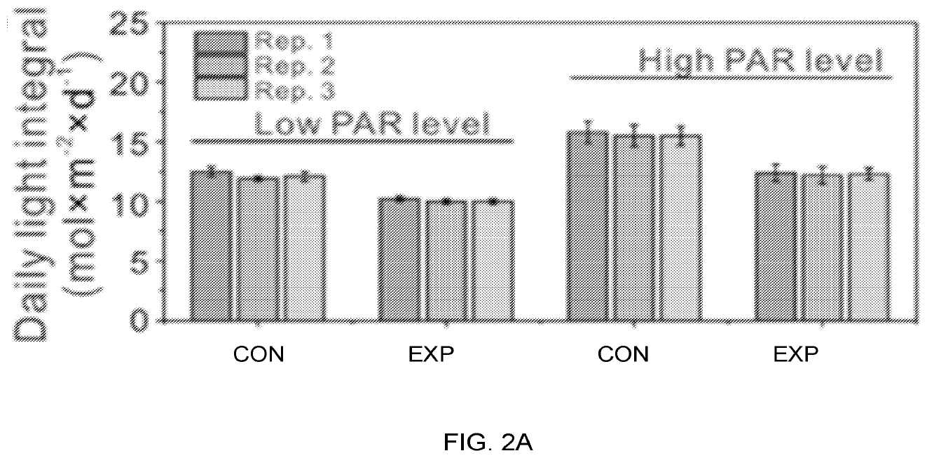

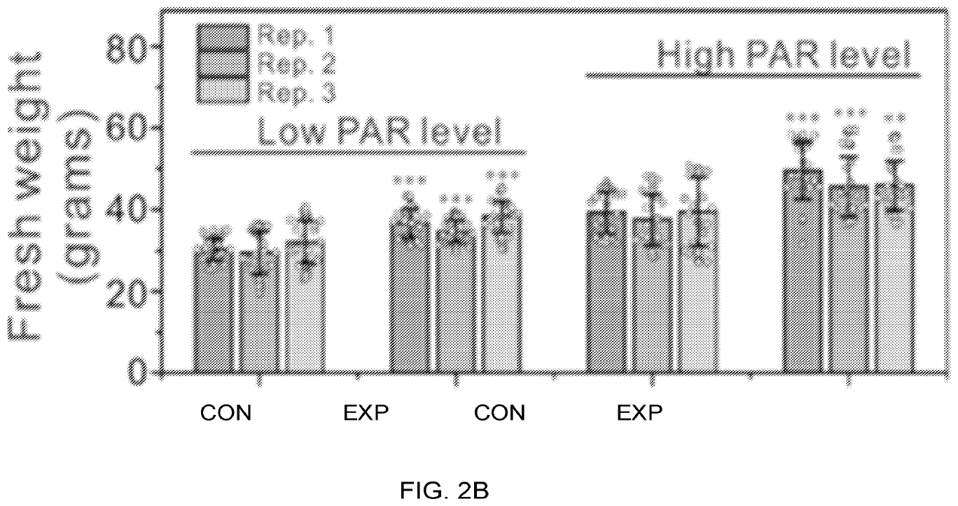

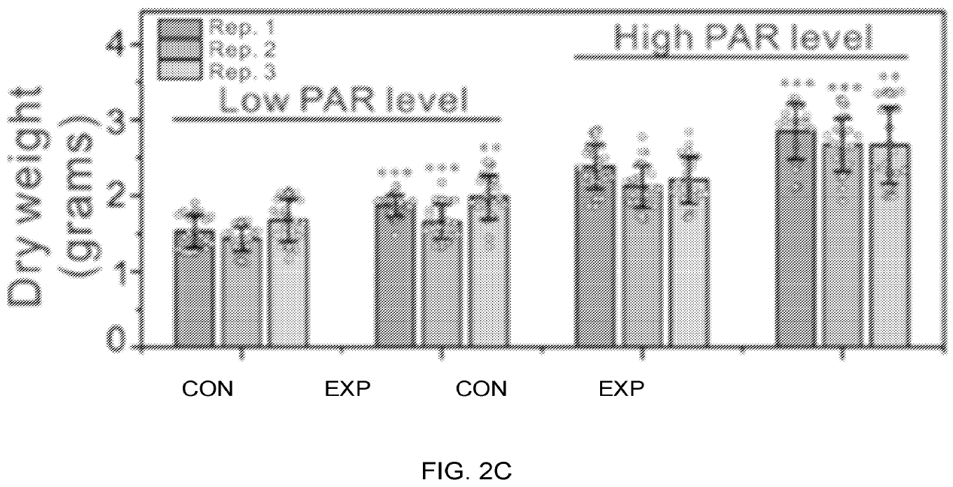

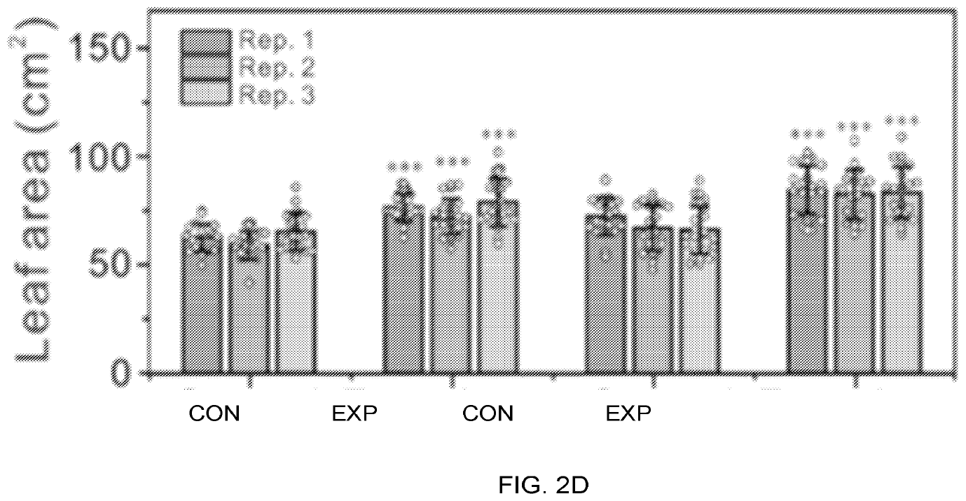

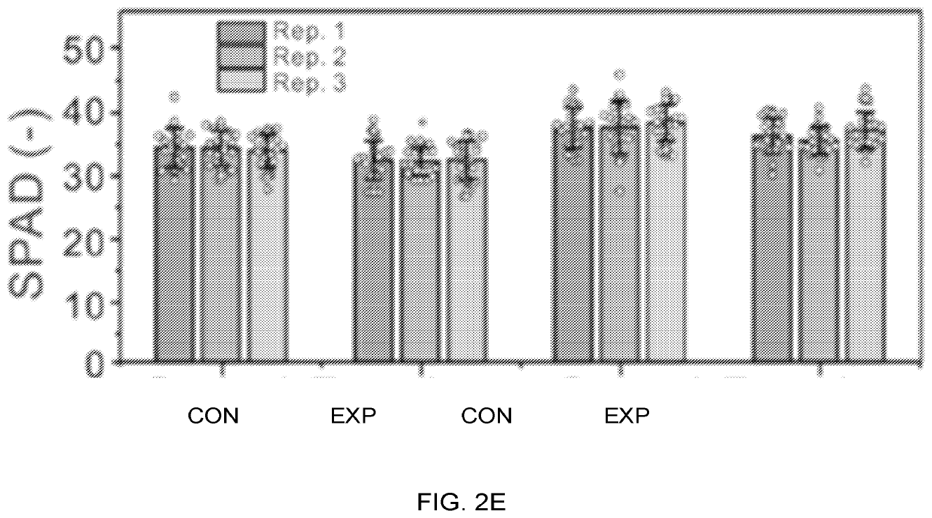

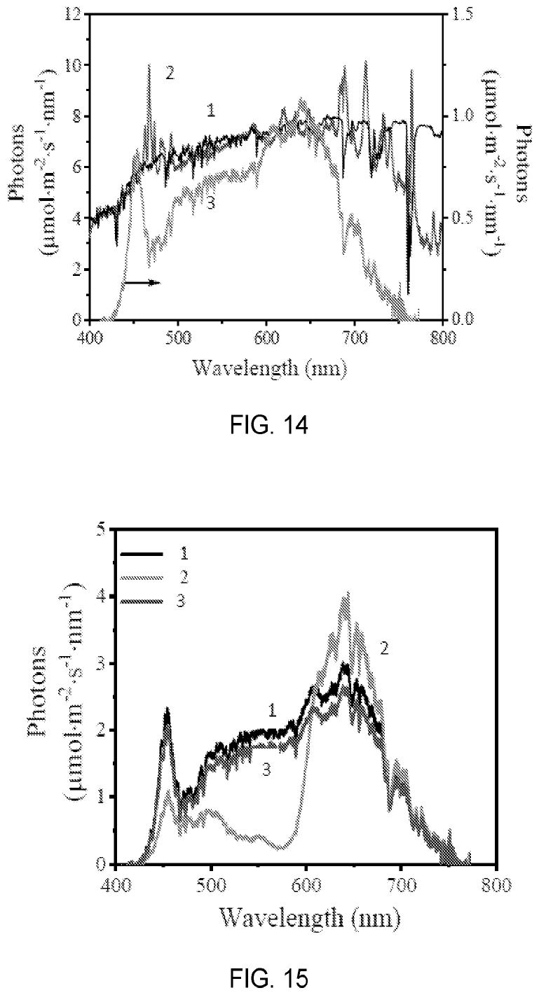

To demonstrate its general use in protected agriculture, the growth of an important leafy green vegetable. Lactuca sativa ‘Buttercrunch’ lettuce (Isla's Garden Seeds) was examined under the unidirectional light-extracting films in a controlled indoor environment (temperature-controlled) with broad spectrum light-emitting diode (LED) grow lights. The photon spectrum of various light sources is shown in FIG. 14. Leafy green lettuce was selected as a model crop for this study because of its short growth cycle and, more importantly, its high sensitivity to photon spectrum (22, 23) FIG. 2A shows the average daily light integral (DLI) at the plant canopy level, i.e., the total number of photosynthetic photons received by plants per square meter during a 24-hour period, under the control and experiment films for both the low and high PAR levels (Table 3). The DLI was monitored under the films at leaf canopy level using a PAR quantum meter (MQ-501, Apogee Instruments, Inc., USA). The unidirectional light-extracting film reduced the average DLI by approximately 20% relative to the control because of non-unity external quantum efficiency and beam spread of light. In stark contrast, the lettuce plants grown under the light-extracting films were all larger in size than those under the control in all experimental replications.

The spectral-shifting and unidirectional light-extracting films significantly increased the aboveground fresh weight (FIG. 2B) and dry weight (FIG. 2C) of lettuce at day 23 after transplant by as much as 19.4±1.6% and 18.7±3.1%, respectively, at the low PAR level. This increase in production is more evident at the high PAR level, where there was a 22.2±3.5% and 22.2±3.3% increase in the aboveground fresh and dry weight, respectively. The passive augmentation in biomass production under the spectral-shifting, unidirectional light-extracting film demonstrated here is mostly attributed to the increased red photon flux density (PFD) and the increased ratio between red to green PFDs (24), from 109:92 to 146:26 (Table 2). In addition, a slightly greater extension growth of the lettuce plants grown under the spectral-shifting films was observed, which was further demonstrated by significantly increased leaf area (FIG. 2D) as well as the plant diameter, leaf length, and leaf width. The extension growth of the lettuce could improve the light capture and indirectly promote the aboveground biomass accumulations (25). On the other hand, the spectral-shifting, unidirectional light-extracting film reduced the blue PFD because of the non-negligible absorption of LF305 (FIG. 1G), and blue light is known to regulate the extension growth and potentially the biomass of lettuce (26, 27).

Comparison indoor growth with the modulated blue PFD, from 10 to 38 μmol·m⁻²·s⁻¹, confirmed the extension growth under reduced blue PFDs, but showed no statistical difference in the aboveground biomass until nearly complete removal of blue PFD. The result indicates that too limited blue light, for instance at a red to blue ratio of 145:5 in this case, might have a detrimental effect on the growth of lettuce Error! Bookmark not defined. (33). It is also important to recognize that the light-extracting films did not alter the soil plant analysis development (SPAD) values (FIG. 2E), which measures the relative leaf chlorophyll concentrations. More details of the indoor growth conditions can be found in the Examples.

### Increased Carbon Dioxide Fixation of a Whole Lettuce Plant

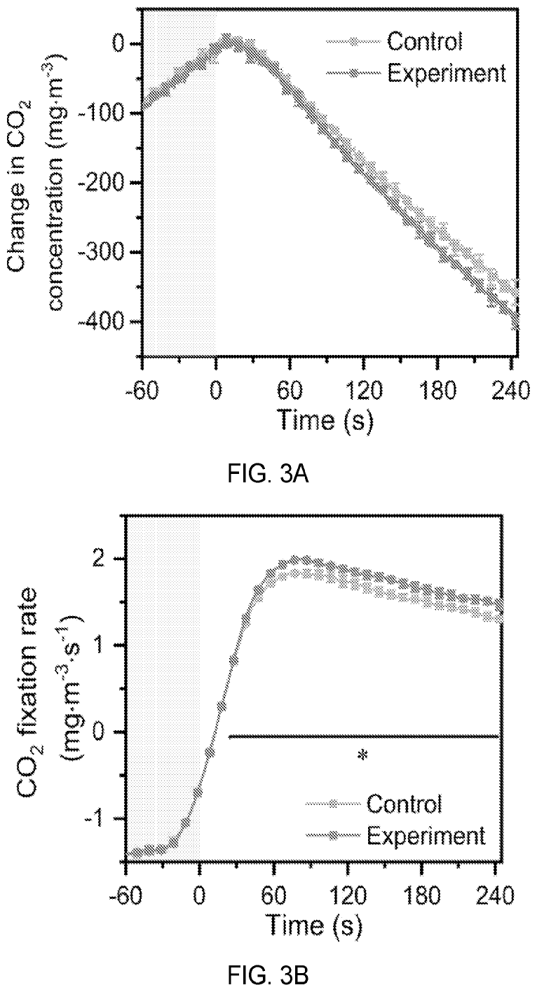

The CO₂ uptake time constant under the unidirectional light-extracting film was significantly faster at an average of 1389 sec versus 1818 sec (P<0.05) under the fluorophore-free film (see Table 4). In both cases, CO₂ assimilation increased immediately after the light was turned on, reaching a maximum and then decreasing gradually (FIG. 3A). Although the light-extracting films decreased the total amount of photosynthetic light by nearly 20% due to the non-unitary external quantum efficiency, a significantly higher CO₂ fixation rate, averaging an increase of ˜10%, was observed under the light-extracting films (FIG. 3B) due to the improved spectrum of photosynthetic light.

Increased Lettuce Production in a Greenhouse with Natural Sunlight

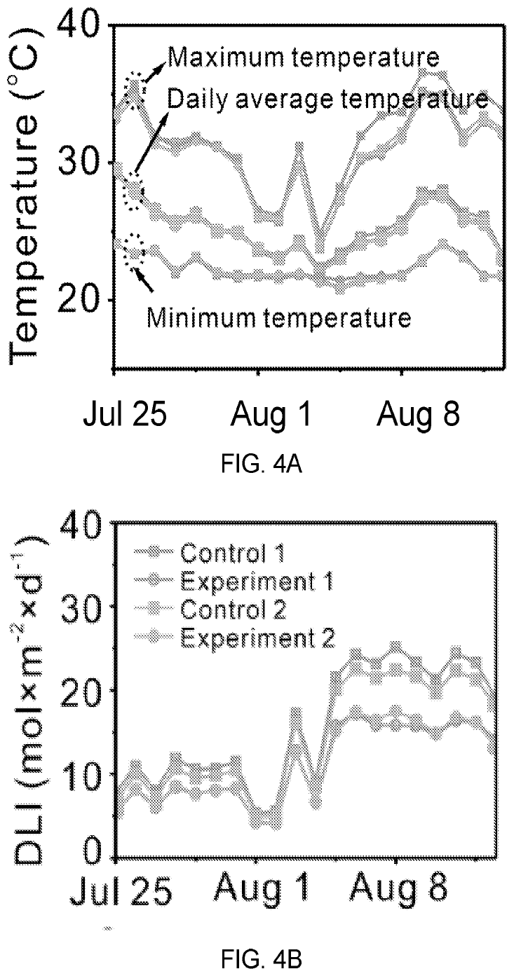

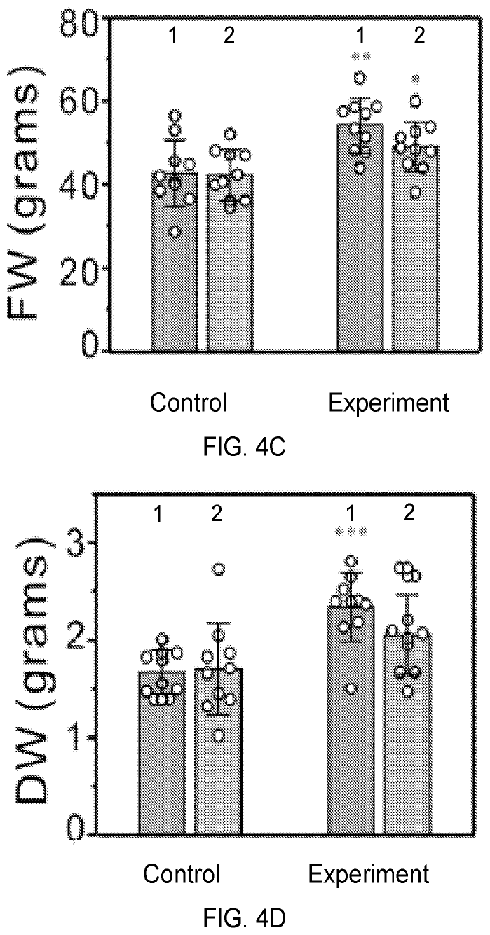

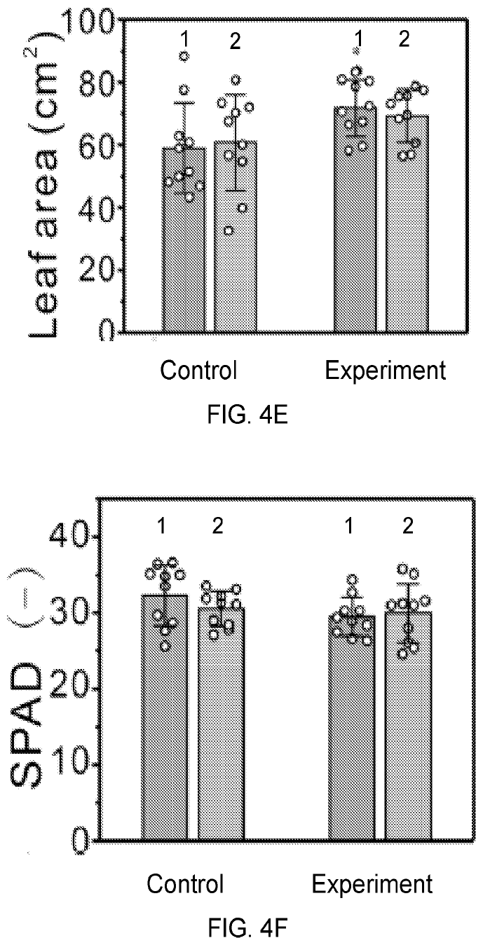

To further demonstrate the general use in a greenhouse setting under natural sunlight, a semi-cylindrical roof dome was constructed using the LF305-doped unidirectional light-extracting film. Comparative growth studies of ‘Buttercrunch’ lettuce were performed. Four semi-cylindrical roof domes (2 controls and 2 experiments) were alternatively arranged on the bench in the greenhouse. Two independent replications of lettuce were carried out in parallel. Each replication had 10 lettuce plants under the fluorophore-free films (control) and 10 plants under the unidirectional light-extracting films (experiment), respectively. FIG. 4A shows the daily average, maximum, and minimum temperatures in each dome. No observable difference in temperature was observed between the domes. The average temperature during the growing periods under the control and the experimental domes was 25.5° C. and 25.4° C. respectively. FIG. 4B shows the DLI under each dome. During the first 10 days, a neutral-density greenhouse shade material with a 55% shade factor was placed overhead to reduce the solar irradiance. The DLI varied as the weather changed. However, the variation between two control domes or two experiment domes was relatively small. The average DLIs under the control and the experimental films were 15.1 mol·m⁻²·d⁻¹ and 11.1 mol·m⁻²·d⁻¹ and the total light integral during the growth period (20 days) was 302 mol·m⁻² and 222 mol·m⁻², respectively. The average DLI under the unidirectional light-extracting film decreased by ˜ 26% compared to that under the control film. In contrast, lettuce growth was consistently greater under the unidirectional light-extracting film. The lettuce plants were generally larger in size than those grown under the controls. The unidirectional light-extracting film significantly increased both the aboveground fresh weight (FIG. 4C) and dry weight (FIG. 4D) of lettuce at day 20 after transplantation by as much as 21.7% and 30.3%, respectively. In addition, the spectral-shifting, unidirectional light-extracting film led to extension growth of lettuce, demonstrated by the increased leaf area relative to that of the control (FIG. 4E).

An increase in plant diameter; leaf number, and length was also observed. The light-extracting film did not alter the relative leaf chlorophyll concentration. SPAD (FIG. 4F). Lastly, as a comparison, the augmentation in the aboveground biomass was also observed outdoors in an open space without any environmental regulation. All raw data of the greenhouse environments are provided in reference 33. This data is incorporated by reference herein for all purposes.

The performance of the unidirectional light-extracting films can be further improved because the current total external quantum efficiency is predominantly limited by the self-absorption of LF305 due to its overlapped absorption and emission spectra (28). Increasing Stokes shifts (i.e., a large separation between absorption and emission peak) with semiconductor nanocrystals (29), rare earth complexes (30) and organic phosphors (31) can further reduce the self-absorption and increase the external quantum efficiency, promoting further the photosynthesis augmentation under the films. More interestingly, spectral shifters with different colors can be readily incorporated into the unidirectional light-extracting films for organisms that acclimate to different spectra and intensities of light for effective photosynthesis (32).

In summary, a unidirectional light-extracting fluorescent film for passive augmentation of photosynthesis and biomass production has been demonstrated for plants, particularly for leafy green lettuces, grown indoors with a well-regulated environment under electric lighting and in greenhouse facilities with a partially regulated environment under natural sunlight. The films and methods described herein can be readily applied to growth of any plant, tree or shrub grown in a controlled environment, using natural sunlight or appropriate artificial grow lights. Methods herein can be employed or readily adapted to grow of house plants, ornamental plants or a variety of crops grown in such controlled environments. The films and methods herein can be employed in growth of seedlings of any type of plant, shrub or tree.

The batch-processed films as described herein have a total light extraction efficiency of 89%, with a majority of the converted light directed towards plants to increase photosynthesis and biomass productions. In an embodiment, the film described herein provides a “red-colored” envelope material for efficient applications in greenhouses and other protected environments and has the potential to increase crop yields.

The disclosure relates to films and sheets which comprise a matrix having a spectral-shifting material or compound distributed in the matrix. The matrix is made of a material, such as a polymer, or inorganic solid that is substantially transparent to light wavelengths useful in a given application. In embodiments, the matrix is substantially transparent to wavelengths of light useful for the growth of plants or other photosynthetic organisms (e.g., algae). Plants is used generically herein to refer to any type of plant including plants, bushes, trees or the like. Plants include among other ornamental plants, crops, vegetables, grasses and in particular includes plants that may be grown in greenhouses. In embodiments, the matrix is a polymer. In embodiments, the matrix is a glass. The disclosure further relates to films or sheets which in addition to the spectral-shifting matrix have at least one surface structure which functions for unidirectional light extraction. In embodiments, this structure is positioned at the top surface of the film or sheet, where the top surface is the surface through which light enters the film or sheet. In embodiments, the top surface of the film or sheet is directed towards a light source (e.g., the sun or artificial light) for receiving light and has a surface through which light exits the film or sheet. In embodiments, the surface through which light exits the film is the bottom surface. In embodiments, a reflector may be employed to direct light from a light source into the top surface of the film or sheet. A film or sheet may comprises multiple layers. In an embodiment, a film or sheet comprises a layer comprising the spectral-shifting matrix and may comprise a second layer which comprises the at least one surface structure for unidirectional light extraction.

In a first aspect, the disclosure provides a spectral-shifting and unidirectional light extracting film or sheet which comprises a matrix having a spectral-shifting material or spectral-shifting compound distributed therein, wherein the film also comprises at least one surface structure that functions for unidirectional light extraction.

In a second aspect, the matrix is substantially transparent to light of a selected wavelength for a given application.

In a third aspect, the disclosure provides a method for delivering a selected shifted wavelength range to a selected location from a source of illumination (light source, including the sun) which comprises positioning a film or sheet of aspect 1 or 2 between the source and the delivery location, such that light from the source passes through the thickness of the film or sheet and the selected shifted wavelength range is delivered to the selected location.

In a fourth aspect, the disclosure provides a method for enhancing the growth of a seed, seedling or plant which comprises delivery of a selected shifted wavelength range suitable for growth enhancement of the seed, seedling or plant to a location containing the seed, seedling or plant, wherein a film or sheet of aspect 1 or 2 is positioned between the source of illumination and the location and where the spectral-shifting material or spectral-shifting compound is selected to provide the selected shifted wavelength range.

In a fifth aspect, the disclosure provides a window comprising the film or sheet of aspect 1 or 2 wherein the window is at least in part covered by the film or sheet such that at least in part light entering the window is spectrally shifted by passage through the film or sheet.

In a sixth aspect, the disclosure provides a greenhouse wherein the film or sheet of aspect 1 or 2 covers at least a portion of the windows in the greenhouse such that at least in part light entering the greenhouse is spectrally shifted by passage through the film or sheet.

In another aspect, the matrix of any preceding aspect is a polymer matrix which is substantial transparent to light wavelengths useful in a selected application.

In another aspect, the matrix of any preceding aspect comprises or is a polymer selected from poly (methyl methacrylate), polyethylene (including HDPE, or LDPE), an acrylic polymer, polyethylene terephthalate (including among others biaxially-oriented polyethylene terephthalate), polyvinylidene fluoride, ethylene tetrafluoroethylene, polycarbonate, cellulose acetate and mixtures thereof.

In another aspect, the matrix of any preceding aspect is a solid which is substantial transparent to light of wavelengths useful in a selected application and into which the spectral-shifting material or spectral-shifting compound can be introduced and distributed.

In another aspect, the matrix of any preceding aspect is a solid and is optionally glass or quartz.

In another aspect, the spectral-shifting material or spectral-shifting compound in the matrix of any preceding aspect is or comprises a molecular dye, a quantum dot or a phosphorous compound.

In another aspect, the spectral-shifting material or spectral-shifting compound of any preceding aspect is or comprises a perylene fluorescent dye and optionally is LF305.

In another aspect, the spectral-shifting material or spectral-shifting compound of any preceding aspect is or comprises an organic phosphor.

In another aspect, the spectral-shifting material or spectral-shifting compound of any preceding aspect is or comprises a rare earth complex.

In another aspect, the film or sheet of any preceding aspect comprises two or more layers.

In another aspect, the film or sheet of any preceding aspect comprises two or more layers and the spectral-shifting material or spectral-shifting compound is in a layer different than the layer which comprises the surface structure.

In another aspect, the film or sheet of any preceding aspect comprises one or more layers and the spectral-shifting material or spectral-shifting compound is in the same layer which comprise the surface structure.

In another aspect, the film of any preceding aspect is supported on a substantially transparent substrate, which is optionally glass or quartz.

In another aspect, the film or sheet of any preceding aspect has a top surface through which light enters and a bottom surface through which light exits.

In another aspect, the film or sheet of any preceding aspect has a top surface through which light enters and a bottom surface through which light exits and the at least one surface structure is formed on the top surface.

In another aspect, the film or sheet of any preceding aspect has a top surface through which light enters and a bottom surface through which light exits and the at least one surface structure is formed on the bottom surface.

In another aspect, the film or sheet of any preceding aspect has a top surface through which light enters and a bottom surface through which light exits and the at least one surface structure is formed on the bottom surface and at least one surface structure is formed on the bottom surface and at least one surface structure is formed on the top surface.

In another aspect, in the film or sheet of any preceding aspect, the at least one surface structure has at least one dimension that is microscaled.

In another aspect, in the film or sheet of any preceding aspect, the at least one surface structure has two dimensions that are microscaled.

In another aspect, in the film or sheet of any preceding aspect, the at least one surface structure comprises microdomes.

In another aspect, in the film or sheet of any preceding aspect, the at least one surface structure comprises an array of microdomes.

In another aspect, in the film or sheet of any preceding aspect, the at least one surface structure comprises microdomes wherein a microdome has a height ranging from about 50 to about 100 microns.

In another aspect, in the film or sheet of any preceding aspect, the at least one surface structure comprises microdomes wherein a microdome has a period of 300 to 500 microns.

In another aspect, in the film or sheet of any preceding aspect, the at least one surface structure comprises microdomes wherein a microdome has a height ranging from about 50 to about 100 micron and a period of 300 to 500 microns.

In another aspect, in the film or sheet of any preceding aspect, the at least one surface structure comprises an array of micro-domes and wherein a microdome has a height ranging from about 50 to about 100 microns.

In another aspect, in the film or sheet of any preceding aspect, the at least one surface structure comprises an array of microdomes wherein a microdome has a period of 300 to 500 microns.

In another aspect, in the film or sheet of any preceding aspect, the at least one surface structure comprises an array of microdomes wherein a microdome has a height ranging from about 50 to about 100 micron and a period of 300 to 500 microns.

In another aspect, in the film or sheet of any preceding aspect, the at least one surface structure comprises an array of microdomes wherein the array of microdomes is close-packed.

In another aspect, the film or sheet of any preceding aspect has a thickness ranging from 5 microns up to 10 millimeters.

In another aspect, the film or sheet of any preceding aspect has a thickness ranging from 5 micron to 500 micron or from 20 micron to 500 micron, or from 20 micron to 300 micron, or form 100 micron to 300 micron.

In another aspect of preceding method aspects, the delivery location is into a greenhouse for illumination of plants therein.

In another aspect of preceding method aspects, the delivery location is plantings, seedlings or growing plants.

In another aspect of any preceding method aspect, the film or sheet is positioned on a greenhouse or other plant growth structure.

In another aspect of any preceding method aspect, the source of illumination is natural sunlight, filtered sunlight, artificial light or one or more LED lights

All patents and publications mentioned in the specification are indicative of the levels of skill of those skilled in the art to which the invention pertains. All references cited herein are hereby incorporated by reference, as though individually incorporated by reference, to the extent not inconsistent with the disclosure herewith. All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim.

When a group of substituents is disclosed herein, it is understood that all individual members of those groups and all subgroups, including any isomers, enantiomers and diastereomers of the group members, and classes of compounds that can be formed using the substituents are disclosed separately. When a compound is claimed, it should be understood that compounds known in the art including the compounds disclosed in the references disclosed herein are not intended to be included. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Every device, system, formulation, combination of components, or method described or exemplified herein can be used to practice the invention, unless otherwise stated. One of ordinary skill in the art will appreciate that methods, device elements, starting materials, synthetic methods, analytical methods, assay methods, biological methods, and plant growth methods other than those specifically exemplified can be employed in the practice of the invention without resort to undue experimentation. All art-known functional equivalents, of any such methods, device elements, starting materials and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

Without wishing to be bound by any particular theory, there may be discussion herein of beliefs or understandings of underlying principles relating to the materials, devices and methods disclosed herein. It is recognized that regardless of the ultimate correctness of any mechanistic explanation or hypothesis, an embodiment of the invention can nonetheless be operative and useful.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein.

As used herein, “comprising” is synonymous with “including.” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim.

In an embodiment herein, films herein consist essentially of a matrix carrying a spectral-shifting material or compound or component and any other component that in the amount the component is present in the film does not materially affect the optical or photonic properties of the film with respect to the selected spectral-shifting and light extracting properties as described herein. In such an embodiment, the film may contain one or more additional component, such as a plasticizer, or surfactant, that facilitates combination of components or manufacture of the film or improves mechanical properties of the film, so long as such additional components are present in the film in an amount that does not affect the photonic or optical properties for spectral shifting and light extraction as described herein.

Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

In general the terms and phrases used herein have their art-recognized meaning, which can be found by reference to standard texts, journal references and contexts known to those skilled in the art. The preceding definitions are provided to clarify their specific use in the context of the invention.

Although the description herein contains many specificities, these should not be construed as limiting the scope of the invention but as merely providing illustrations of some of the presently preferred embodiments of the invention. For example, thus the scope of the invention should be determined by the appended claims and their equivalents, rather than by the examples given.

The invention may be further understood by the following non-limiting examples.

### THE EXAMPLES

Shen et al. (Jun. 18, 2021) “Increasing greenhouse production by spectral-shifting and unidirectional light-extracting photonics,” Nature Food, Vol 2 pages 434-441 (Doi.org/10.1038/s43016-021-00307-80) and the corresponding Supplementary Information available at https//doi.org/10.1039-8/s43016-021-00307-8 are each incorporated by reference in its entirety herein to provide additional detail of the Examples.

### Example 1: Light Extraction Efficiency and External Quantum Efficiency of a Fluorescent Film

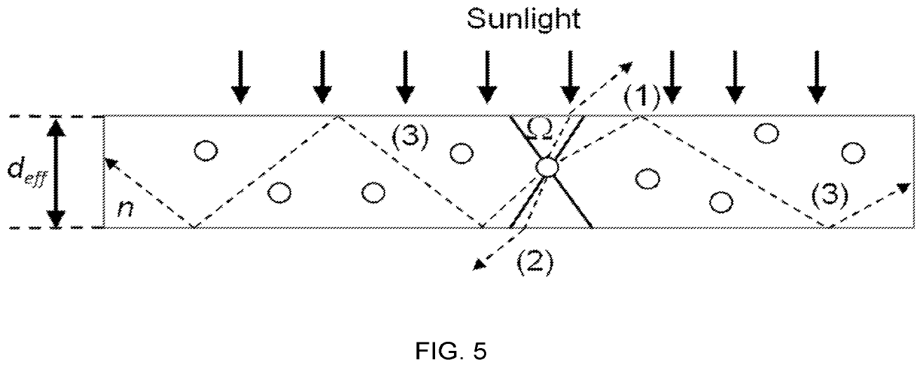

FIG. 5 shows a diagram of a fluorescent film illuminated with normally incident sunlight. The top and bottom surfaces can be flat (as shown) or be incorporated with surface light-extracting structures, as discussed elsewhere herein. As illustrated, the top surface is the surface for light entry and the bottom surface is for light exit. This convention will be employed throughout this specification. With surface light-extracting structures, the film has an effective thickness of d_{eff}, which is defined as a thickness required to obtain the same volume of materials as that of a planar film. It is assumed that all fluorophores emit isotropically and are homogeneously distributed in the film. The hosting matrix material has a refractive index n for the wavelength of interest.

When fluorophores absorb impinging sunlight and re-emit, all internally emitted photons (Φ_{emitted}) can be divided into (1) emission in the backward direction (Φ_{backward}), (2) emission in the forward direction (Φ_{forword}), and (3) the photons that are trapped inside the film (Φ_{trapped}) due to total internal reflections. The light extraction efficiency (η_{extraction}) and the forward viewing light extraction efficiency (η_{extraction}^{forward}) are straightforwardly defined as,

$${η}_{extraction} = \frac{{Φ}_{forward} + {Φ}_{backward}}{{Φ}_{emitted}} \qquad ( 1 )$$

$${η}_{extraction}^{forward} = \frac{{Φ}_{forward}}{{Φ}_{emitted}} \qquad ( 2 )$$

The total external quantum efficiency (η_{EQE}) is therefore,

$${η}_{EQE} = \frac{{Φ}_{forward} + {Φ}_{backward}}{{Φ}_{absorbed}} = {η}_{QE} \cdot {η}_{extraction} \qquad ( 3 )$$

Here

$${η}_{QE} = \frac{{Φ}_{emitted}}{{Φ}_{absorbed}}$$

is the internal quantum efficiency of fluorophores and Φ_{absorbed} is the total number of photons being absorbed from sunlight. The external quantum efficiency in the forward direction is defined in the same manner, η_{EQE}^{forward}=η_{QE}·η_{extraction}^{forward}. It is also assumed that there is no absorption of the internally emitted photons. When self-absorption is considered, i.e., the internally generated photons are partly re-absorbed by other fluorophores before exiting the film, one has to take the self-absorption efficiency η_{self_absorption} into account,

$${η}_{EQE} = {η}_{QE} \cdot {η}_{extraction} \cdot ( 1 - {η}_{self \_ absorption} ) \qquad ( 4 )$$

The self-absorption effect, as demonstrated by the experiments and the Monte Carlo ray tracing method (herein below), is the limiting factor for the total η_{EQE} of the light-extracting fluorescent film.

Geometric Optics Limit of Light Extraction from a Planar Fluorescent Film

The theoretical limit of light extraction efficiency for a planar fluorescent film can be determined analytically when self-absorption is neglected. When the internally generated photons propagate towards the material-air interface, only those photons emitted within the escape light cone (Ω, see FIG. 5) defined by the critical angle

$${θ}_{c} = {sin}^{- 1} ( \frac{1}{n} )$$

can exit. The geometric optics limit of light extraction efficiency in the forward viewing direction from a planar fluorescent film is,

$${η}_{extraction}^{forward} = \frac{Ω}{4 π} = \frac{1 - \sqrt{1 - 1 / {n}^{2}}}{2} \qquad ( 5 )$$

Assuming the fluorescent film has a reflective index of n=1.5, the forward viewing light extraction efficiency is merely 12.7%, i.e., nearly 75% of the internally emitted photons are trapped inside the film. When the self-absorption effect is considered, the percentage of light extracted will be even lower. A light-extracting structure is incorporated to maximize the use of the internally emitted photons.

### Self-Absorptions

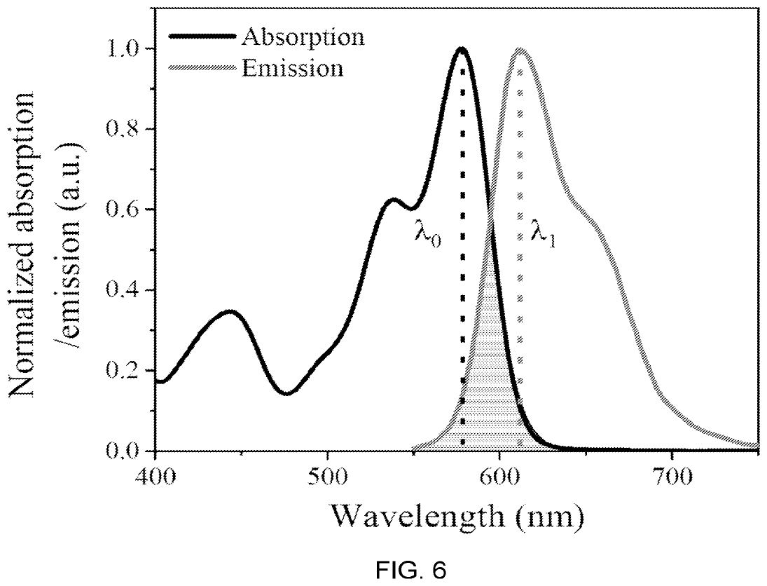

Self-absorption is an energy dissipation process in which the internally generated photons are partly absorbed by the fluorophores before exiting the fluorescent material. This can be visualized as an overlap (indicated by the shaded region in FIG. 6) between the normalized spectra of absorption A(λ) and emission F(λ) of the fluorophores (exemplary spectral-shifting compound) (34). The self-absorption process of the fluorophores can also be quantitatively determined by the Monte Carlo Ray Tracing method (see “Monte Carlo Ray Tracing of Unidirectional Light-extracting Film,” below) or assessed by the self-absorption cross-section (35):

$${σ}_{SA} = \frac{{\int }_{0}^{∞} A ( λ ) \cdot F ( λ ) d λ}{{\int }_{0}^{∞} F ( λ ) d λ} \qquad ( 6 )$$

The self-absorption cross-section, σ_{SA} provides a reliable criterion for comparing the performance of various fluorophores. In practice, it is sensitive to the concentration of the fluorophores and the geometric parameters of the fluorescent film. For example, in a planar fluorescent thin film, increasing the film thickness or the fluorophore concentration reduces the η_{EQE} because of the increase of re-absorption events. All trapped photons in a fluorescent film will be ultimately re-absorbed and dissipated. Improving the light-extracting efficiency substantially reduces overall self-absorption events that occur in the film.

### Light Extraction of a Structured Fluorescent Film

Micro- and nano-structures can be incorporated to improve the light extraction efficiency, which has been widely used in modern optoelectronic devices and optical systems. If there is no internal absorption, any optical structures, even light scatters, can eventually extract all internally generated light through multiple scattering events. It is the thermodynamics of the self-absorbing fluorophores that limit the total amount of light that can be extracted from a fluorescent film.

A simple analysis is used that argues the general condition for efficient light extraction based on the mean free path (l), which is the average distance that a photon travels through a fluorescent material without being absorbed.

$$l = \frac{1}{〈 n 〉 \cdot {σ}_{eff}} \qquad ( 7 )$$

Here [symbol] n [symbol] is the number of fluorophores per unit volume of the host material and σ_{eff} is the effective absorption cross-section area of the fluorophore. The mean free path is wavelength dependent. At the wavelength of peak absorption (λ₀), the effective absorption cross-section is much greater than that at the wavelength of peak emission (λ₁) (see. FIG. 6), i.e., the mean free path l(λ₀)<</(λ₁). Ideally, for an efficient light-extracting film, its effective thickness (d_{eff}) has to satisfy,

$$l ( {λ}_{0} ) << {d}_{eff} << l ( {λ}_{1} ) \qquad ( 8 )$$

This allows the fluorescent film to absorb sufficiently large amounts of impinging photons of sunlight centered at λ₀ without loss of a significant number of photons centered at λ₁ due to self-absorptions. The mean free path at these wavelengths can be experimentally determined (36). For the exemplary unidirectional light-extracting film demonstrated in this work (0.1 wt. % LF305 in PMMA, see the section on “Unidirectional Light-extracting Film Fabrication and Characterization”), the mean free path of photons at wavelengths λ₀ (576 nm) and λ₁ (612 nm) are 105 μm and 1,030 μm, respectively. The effective thickness of the film is 210 μm. This value is well within the range and, in fact, designed by the ray-tracing method with self-absorption effect considered.

### Monte Carlo Ray Tracing of Unidirectional Light-Extracting Film

Monte Carlo ray tracing method simulates statistically the photon transport in an optical system by sampling, tracking and integrating random optical rays (37). The technique provides accurate assessments of transmittance, reflectance and absorbance of optical systems and, more importantly, enables us to simulate photophysical processes of spectral-shifting and self-absorption of fluorophores.

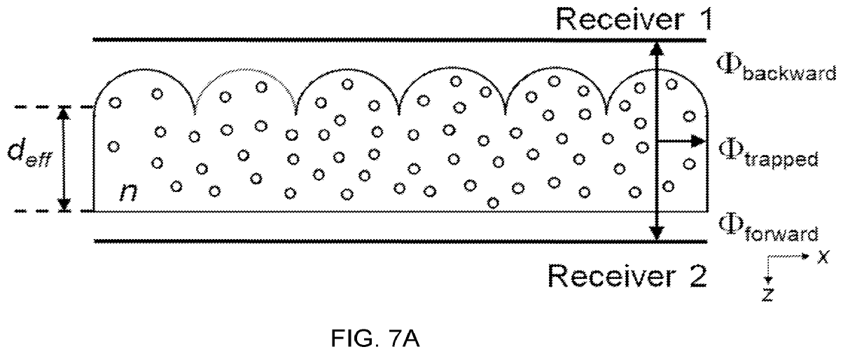

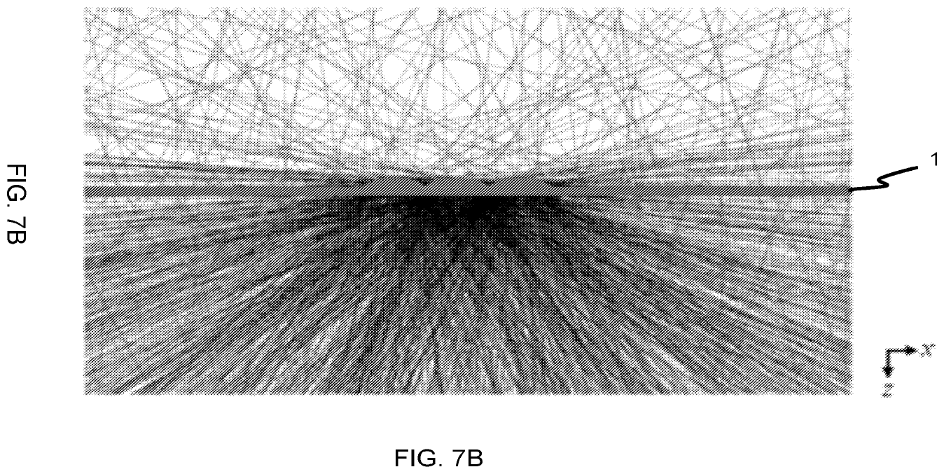

The microstructure geometries and size parameters were designed and optimized by the ray-tracing method. FIGS. 7A and 7B schematically illustrates the ray-tracing model of the unidirectional light-extracting film. The micro-dome structure (FIG. 7A) is closely packed on a square lattice with a period of 400 μm (P, distance between peaks of domes) and a height (h, from film base to top of dome) of 65 μm. The entire structure contains 0.1 wt. % of LF305 distributed isotropically and uniformly distributed inside the film. Two receivers are respectively placed next to the top and bottom surfaces of the film with a fixed gap distance of 1 μm to integrate the escaped photons in the forward and backward directions. To ensure accuracy, the simulation space spans a size of 10 mm×10 mm (625 micro-domes) in x-y plane, and more than 106 rays in total are traced with a relative power truncation threshold of 10-6. FIG. 7B shows the enhanced light extraction from the micro-dome structures using ray trajectories. For the purpose of clarity, only 3×3 micro-domes were used in the center of the simulation space and 1,000 rays are shown. FIG. 7B clearly shows that the internally generated photons are much more effectively extracted in the forward viewing direction of the microstructured region.

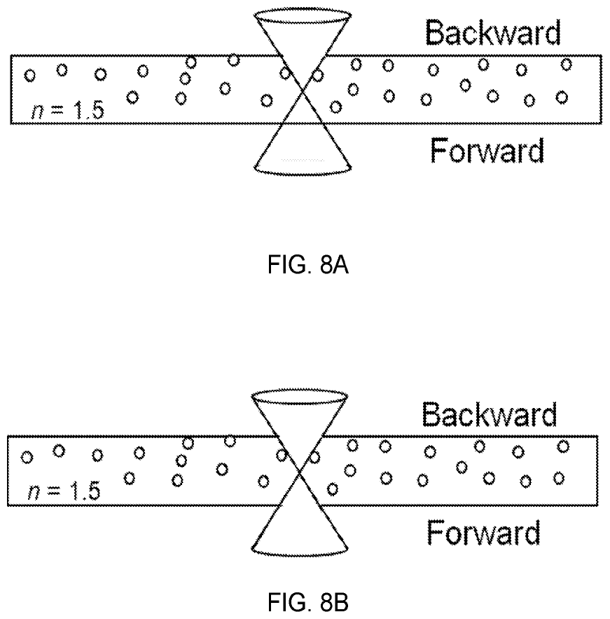

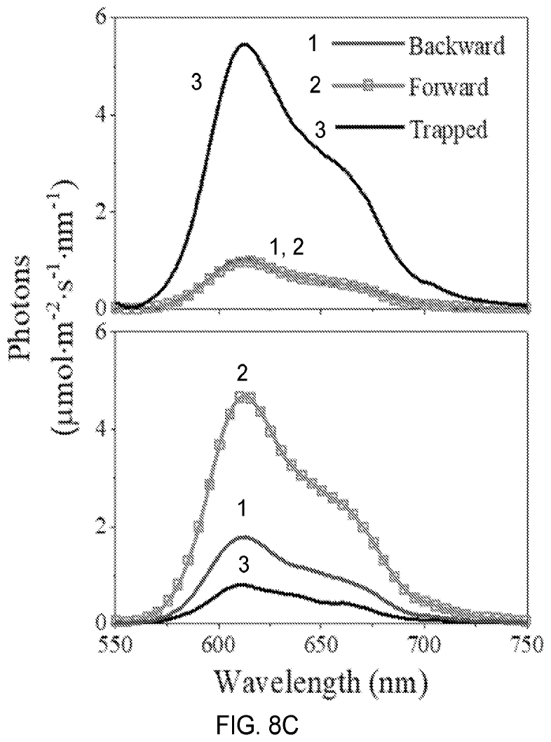

In FIGS. 8A and 8B, the light-extracting effect between the planar fluorescent film (FIG. 8A) and the unidirectional light-extracting film (FIG. 8B) where no self-absorption effect of fluorophores was first assumed. The spectral irradiance of the backward photons (1), forward photons (2) and trapped photons (3) for a planar and a unidirectional light-extracting photonic thin film are shown in FIG. 8C (top and bottom), respectively. Here the normalized emission spectrum of LF305 (FIG. 6) is used as the probability function of fluorophore emissions in the Monte Carlo simulation. For a planar film, only small portions of the internally generated photons can escape from the narrow escape light cone (FIG. 8A), emitting approximately 13% of the internally generated photons equally in both forward and backward directions (FIG. 8C, top), which is consistent with the theoretically calculated value of 12.7% (Eq. 5). In contrast, the microdome structures lead to a unidirectional light extraction in the forward direction (FIG. 8B) and have a total light extraction efficiency of η_{extraction}≈89% and the forward-viewing light extraction efficiency of η_{extraction}^{forward}≈65% (FIG. 8C, bottom).

The photon absorption of each fluorophore was then simulated by employing the actual absorption spectrum of LF305 as a normalized probability function. The probability for a photon or a ray striking a fluorophore is determined by its mean free path. When internal quantum efficiency η_{QE} is 90% (21), the ray tracing results show the total external quantum efficiency of η_{EQE}=44% and the forward-viewing external quantum efficiency of η_{EQE}^{forward}=29% for the unidirectional light-extracting film, much greater than that of a planar fluorescent thin film of 9%.

Self-absorption remains a key limitation in the performance of the spectral-shifting, unidirectional light-extracting film. The self-absorption efficiency is 45% (Eq. 6) in the unidirectional thin film because of photon recycling and therefore elongated light paths. Increasing Stokes shifts (i.e., a large separation between absorption and emission peak) or reducing self-absorption cross-section per optical path length (i.e., a small overlap between absorption and emission spectrum) with semiconductor nanocrystals (29), rare earth complexes (30) and organic phosphors (31) can further reduce the self-absorption and increase the η_{EQE}^{forward} of the unidirectional light-extracting optical thin film.

### Example 2: Unidirectional Light-Extracting Film Fabrication and Characterization

An exemplary unidirectional light-extracting film with microdome surface structure was cast-molded with an automated blade coating film applicator (MSK-AFA-II, MTI Corp.) (FIG. 9) using a polyether ether ketone (PEEK) replica mold with inverse structures of the microdomes. The inverse structures were manufactured by a precision computer numerical control (CNC) machine. An adjustable blade was used to control the wet film thicknesses. The fluorescent polymer solution was prepared by dissolving the fluorophore (LF305) and the commercial grade Poly(methyl methacrylate) (PMMA) or cellulose acetate (CA) in N, N-Dimethylformamide (DMF) at ambient temperature for 24 hours with mechanical stirring. Solutions with different weight fractions of fluorophore were prepared following the same procedure. PMMA and CA films provide nearly identical optical performances. PMMA film is more flexible and was used for indoor, greenhouse, and outdoor growth experiments. The as-cast film was subsequently dried at 60° ° C. for 90 min and then released from the mold in water at ambient temperature. Similar procedures were carried out for preparing the fluorophore-free film. When preparing the planar film, a glass plate was used as the substrate for blade coating.

The forward spectral irradiance of the films was measured using a spectroscopic integrating sphere (IS200-4, Thorlabs Inc.) under a solar simulator (91192A, Newport Inc.). The films were held flat with collimated light impinging at its surface normal direction. Both the transmitted light and the extracted fluorescence in the forward direction were collected by a fiber spectrometer (USB4000, Ocean Optics Inc.). The absorption spectra of the films were characterized with UV-VIS-NIR spectrophotometer (UV-3101PC, Shimadzu Inc.). The surface topography of the fabricated structures was investigated by optical interferometry (NT2000, Wyko Inc.).

### Experimental Measurement of Forward-Viewing External Quantum Efficiency

Experimental measurements of the forward spectral irradiance of a planar fluorophore-free film (2), a planar fluorescent film (1), and a unidirectional light-extracting film (4) are plotted in FIG. 10 (also shown as FIG. 1G). The spectra were measured under the emulated one-sun AM1.5 irradiation (91192A Solar simulator, Newport Inc.) using a spectroscopic integrating sphere (IS200-4, Thorlabs Inc.). The shaded regions above curve 2, but below curves 1 and 4, approximate the number of the extracted photons in the forward direction Φ_{forward}^{exp}, and the shaded regions below the curve 2, but above curves 1 and 4, approximate the number of the photons being absorbed inside the film Φ_{absorbed}. Therefore, the forward viewing external quantum efficiency for the experimental film can be evaluated from the spectra,

$${η}_{EQE}^{exp \_ forward} = \frac{{Φ}_{forward}^{exp}}{{Φ}_{absorbed}} \qquad ( 9 )$$

From FIG. 10, the experimental forward-viewing external quantum efficiencies are 9% and 27% for the planar fluorescent film and the unidirectional light-extracting film, respectively. These values agree well with predictions from the ray-tracing method. Table 1 summarizes the light-extracting properties of both the planar fluorescent film and the unidirectional light-extracting film with comparison to the experimental results.

TABLE 1
Summary of the external quantum efficiency and light-extracting
properties of the planar fluorescent film and the unidirectional
light-extracting film (doped with LF305).

| | | Planar | Unidirectional |
|---|---|---|---|
| | | fluorescent film | light extracting film |
| Ray-tracing | η_{extraction} | 25% | 89% |
| results | η_{extraction}^{forward} | 13% | 65% |
| | η_{self}_{_{—}}_{absorption} | 21% | 45% |
| | η_{EQE} | 18% | 44% |
| | η_{EQE}^{forward} | 9% | 29% |
| Experimental | η_{EQE}^{exp}^{_{—}}^{forward} | 9% | 27% |
| results | | | |

### Example 3: Incident Angle Dependence of the External Quantum Efficiency

Due to the existence of the surface micro-structures, the performance of the spectral-shifting, unidirectional light-extracting film can be sensitive to the light incident angle. In addition, when the unidirectional light-extracting film is used in practice, e.g., for greenhouses, the incidence changes as a function of solar altitude. Detailed theoretical and experimental analysis is here provided on how incident angle impacts the transmission, total external quantum efficiency (EQE), and sunlight (when used outdoors) received after passing through the unidirectional light-extracting film.

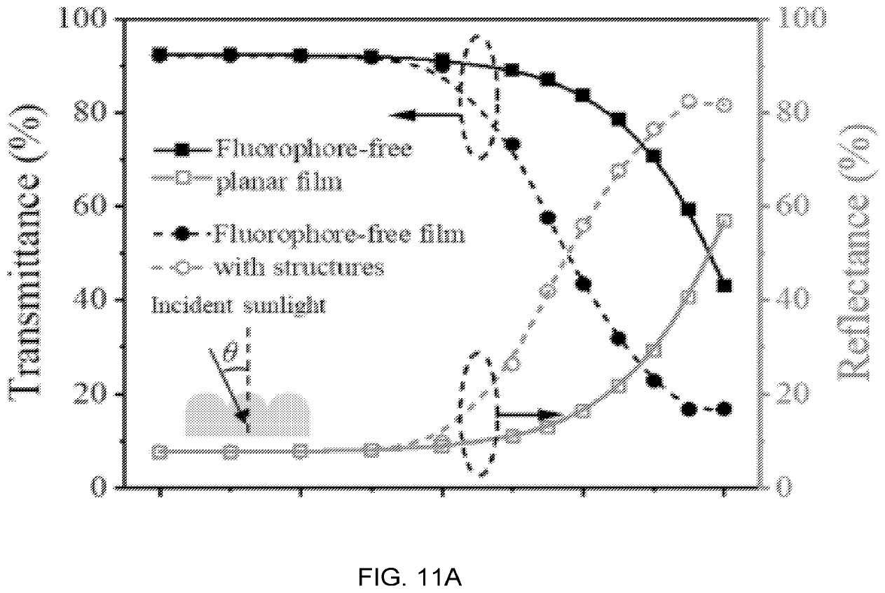

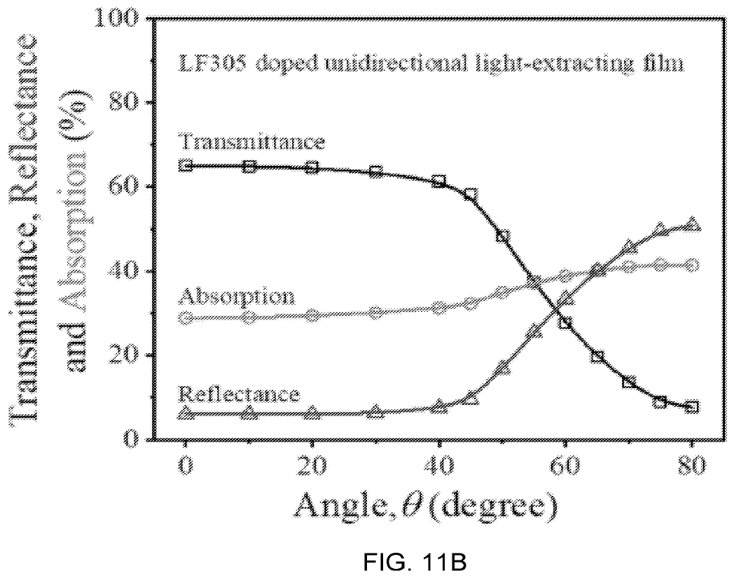

To understand the impact of the surface micro-structures for light coupling, the analysis starts with the films without fluorophores using the Monte Carlo ray-tracing method. FIG. 11A shows the transmittance and reflectance of a fluorophore-free film with the light-extracting structures (dashed lines) and a fluorophore-free planar film (solid lines) as a function of the incident angle. The reflectance of any planar dielectric material rapidly increases when the incident angle is larger than 50°. The transmittance of the fluorophore-free planar film therefore decreases at large incident angles. The behavior can also be predicted using the Fresnel Equations (38) (closed squares, open squares and solid lines in FIG. 11A). Similarly, the reflectance of the film with light-extracting structures (dashed lines) increases while the transmittance decreases, when the incident angle is greater than 40°. The earlier onset of the transmittance/reflectance changes of the fluorophore-free film with the surface micro-structures indicates there is more light being coupled into the film at large incident angles.

FIG. 11B shows the simulated transmittance, reflectance, and absorption of the spectral-shifting, unidirectional light-extracting film doped with LF305. As shown in FIG. 11B, the absorption of the LF305 doped unidirectional light-extracting film slightly increases from approximately 30% to 40% at the large incident angles, further demonstrating that there is about 10% more light in-coupled into the film due to surface micro-structures. The increased in-coupling of light into the unidirectional light-extracting film at large incident angles allows more absorption and therefore leads to more emissions in the red.

Because the emissions from the homogeneously distributed fluorophores are highly isotropic, the surface micro-structures extract approximately the same fractions of the internally emitted photons irrespective of the incidence angles. Therefore, the total external quantum efficiency, η_{EQE}, and the forward external quantum efficiency, η_{EQE}^{forward}, remains nearly unchanged. However, the level of self-absorption can also change slightly with the strength of the absorption and the internal emissions. To elucidate these factors, both the forward and the backward irradiance spectra of the unidirectional light-extracting film under the illumination of emulated sunlight (AM1.5) were measured as the function of the incident angles. Here both the absorption and emission spectra of the fluorophores were used in the Monte Carlo ray tracing. Analysis of the data collected (not shown, but available in reference 33 and incorporated by reference herein for any purpose) show that the transmission and reflection spectra of both the unidirectional light-extracting film and the fluorophore-free planar film are dependent on the incident angles, especially when the incident angles are large (i.e., greater than 40°). Though the transmission is reduced at a larger incident angle, the total emission of the unidirectional light-extracting film slightly increases due to the increased in-coupling and therefore the increased absorption of light.

Incident angle dependent transmission and absorption of the unidirectional light-extracting film as well as the incident angle dependent self-absorption of the isotropically distributed fluorophores were rigorously assessed. The total external quantum efficiency and the forward external quantum efficiency of the light-extracting film remain nearly unchanged (FIG. 1H).

The impact of solar angles on the unidirectional light-extracting film for field applications (see the later sections for lettuce growth outdoors and in a research greenhouse with sunlight) where the film was used as covering material were experimentally examined. Four identical semi-cylindrical domes (0.5 m in height and 1.5 m in length) were constructed. Two of the domes were constructed with the LF305 doped unidirectional light-extracting film and the other two were constructed with the fluorophore-free film with light-extracting structures to serve as controls. The experimental and control domes were arranged in a staggered manner. In the month of September in the city of Idaho Falls (ID, USA), sunrise and sunset times are approximately 7:00 am and 8:00 pm, respectively. The azimuth angle of the sun ranges from approximately 80° to 280° from sunrise to sunset. The ground level solar irradiance is mainly determined by the solar altitude angle, which peaks at 53.7° at 13:27 (culmination) on September 3^{rd}.

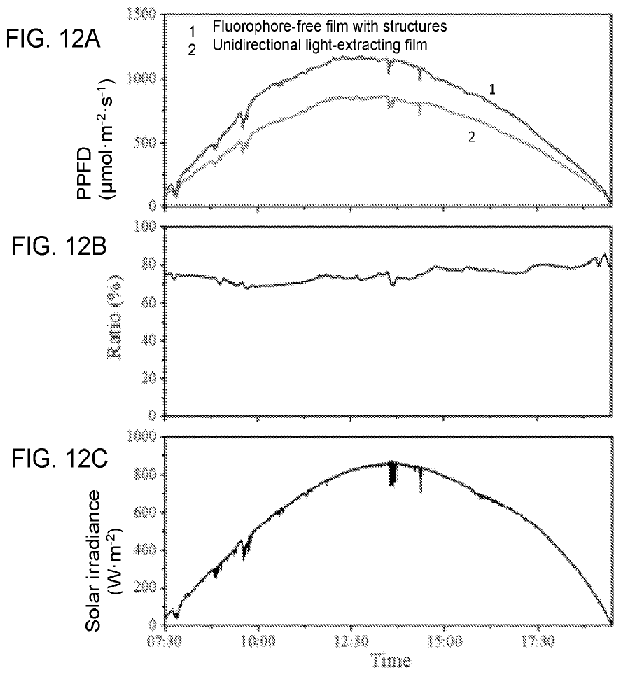

FIG. 12A shows the amount of photosynthetic sunlight received in the greenhouses, i.e. photosynthetic photon flux density (PPFD) underneath the film, from sunrise to sunset on September 3^{rd}. The PPFD was measured by a quantum meter (SQ-520, Apogee Instruments, Inc., USA). The sensors were placed at the center of the dome and the plant canopy level. The PPFD in the early morning and the late afternoon is low due to low solar irradiance (FIG. 12C) at the low altitude angle and the large incidence angle respective to the film. The PPFD ratio between the two greenhouses constructed with the LF305-doped unidirectional light-extracting film and the fluorophore-free film (FIG. 12B) is slightly higher in the early morning and the late afternoon due to the low solar altitude but shows small changes throughout the day. The experimental results further confirm that the solar angle (or the incidence angle) does not strongly impact the forward external quantum efficiency.

### Example 4: Photostability of Unidirectional Light-Extracting Film

Photostability of the fluorophore doped light-extracting films is very important, especially for outdoor greenhouse applications. The photostability of LF305-doped light-extracting films was experimentally examined by exposing the films outdoors under sunlight and other weather conditions such as rain and wind. FIG. 13A shows the forward spectral irradiance of the films measured at Day 1, Day 40, and Day 120, respectively. After 120 days of exposure under sunlight, the irradiance spectra of the films remained unchanged (FIG. 13B), showing no significant photobleaching or color changes. The photostability of the LF305 could be further improved by using UV additives, as LF305-doped devices stabilized with UV additives have passed 20-year UV tests (39).

### Example 5: Indoor Growth of ‘Buttercrunch’ Lettuce

Lettuce was chosen as a model crop because it is an economically important and nutritious vegetable. It is one of the top ten most valuable crops grown in the US and has an annual farm gate value of over $2.3 billion (40). From an experimental perspective, it was also chosen because it is sensitive to the photon spectrum and has been well studied in the literature. In addition, lettuce grows well in moderate light environments.

Seeds of ‘Buttercrunch’ lettuce (Isla's Garden Seeds) were sown in 72-cell self-watering seed starting kits (Burpee, USA). Each cell measured 3.8 cm×3.8 cm×5.1 cm. Seed trays were covered with transparent plastic humidity domes to prevent desiccation during germination. The domes were subsequently removed 4 days after sowing. Seeds were germinated at 22° ° C. with an 18:6-hour light/dark photoperiod and a PPFD of ˜180 μmol·m⁻²·s⁻¹ (See “Lighting Conditions and Spectral Distributions under the Films for Indoor Growth” section for details on the light source and lighting conditions). The seedlings were watered with reverse-osmosis water supplemented with a water-soluble fertilizer (12N-4P-16K, Jack's Nutrients, USA: Epsom Salt, Pennington, USA) to supply the following nutrients (in mg/L): 125 N, 42 P, 167 K, 73 Ca. 49 Mg. 39 S, 1.7 Fe, 0.52 Mn, 0.56 Zn, 0.13 B, 0.47 Cu, and 0.13 Mo (41). The electrical conductivity of the nutrient solution ranged from 1.0-1.2 mS·cm⁻¹. The pH value of the as-prepared solutions was maintained at 5.5-5.8 using potassium bicarbonate.

Ten days after sowing, the seedlings were transplanted into 0.8 L pots (Landmark Plastics, Akron, OH) containing a peat-based substrate (Black Gold, Agawam, MA and were grown with an 18-hour photoperiod (42). Watering was provided as needed (every 2 to 3 days) with reverse-osmosis water supplemented with a water-soluble fertilizer. Six independent replications of lettuces were carried out in parallel. In each replication, the fluorophore-free film with structures (control) and light-extracting film (experiment) was tested, and each replication was comprised of 20 lettuce plants under the control film and 20 plants under the experimental film. These plants were randomized and equally distributed to 4 tiers of two adjacent racks. Racks of control and experiment replications were in a staggered arrangement to reduce environmental variation, such as in ambient temperature, airspeed, and minor light contamination between upper and lower racks. Two different light levels were investigated with an impinging photosynthetic photon flux density (PPFD) of 350 μmol· m⁻²·s⁻¹ and 500 μmol·m⁻²·s⁻¹ for low and high PAR levels, respectively, measured directly above the films (see Supplementary Information for detailed lighting conditions). There were three parallel replications for each PAR level.

Throughout the growth period, the plants were irrigated as needed (every 2 to 3 days) with reverse-osmosis water supplemented with the same water-soluble fertilizer that supplied the following nutrients (in mg/L): 150 N, 50 P, 200 K, 88 Ca, 58 Mg, 47 S, 2.1 Fe, 0.63 Mn, 0.68 Zn, 0.15 B, 0.56 Cu, and 0.15 Mo. The electrical conductivity ranged from 1.5 to 1.8 mS·cm⁻¹ and the pH of the as-prepared solutions was routinely adjusted to 5.5-5.8 using potassium bicarbonate. The air temperature was continuously monitored on each tier of the rack at leaf canopy level using a wireless remote monitoring station.

The experiment and control groups of lettuce plants were placed on the same tier of the rack and illuminated by the same set of LED light tubes. (photographs of the experimental setup and comparative growth of lettuce are found in reference 33, supplemental information). The unidirectional light-extracting film (experiment) and the fluorophore-free film (control) were installed 30 cm above the canopy level. Black cardboard was used to separate the light stand into two regions for different lighting treatments. The lettuce seedlings had a similar architecture on day one, however, the lettuce plants under the experimental film clearly grew larger in size by day 7 compared to those under the control film. The trend became more evident at later stages of growth.

### Lighting Conditions and Spectral Distributions Under the Films for Indoor Growth

Throughout the sowing and growing periods, the lettuces were illuminated by broad-spectrum LEDs (High CRI 95, Active Grow Inc., Seattle, WA). These LEDs are an economic solution for research inside controlled environments, but the spectrum is slightly different from that of the sun. The irradiance spectrum of the LEDs (3) is shown in FIG. 14 and is compared with the AM1.5 solar irradiance (1). The spectrum of the 1-sun solar simulator (91192A Solar simulator. Newport Inc.) is also shown (2) for comparison. The photon flux can be controlled by illuminating different numbers of LED tubes and adjusting their heights. FIG. 15 shows the light spectra directly above (1) and below (3) the fluorophore-free film and the spectral-shifting, unidirectional light-extracting film (2), which were measured using an integrating sphere (IS200-4. Thorlabs. Newton, NJ. USA).

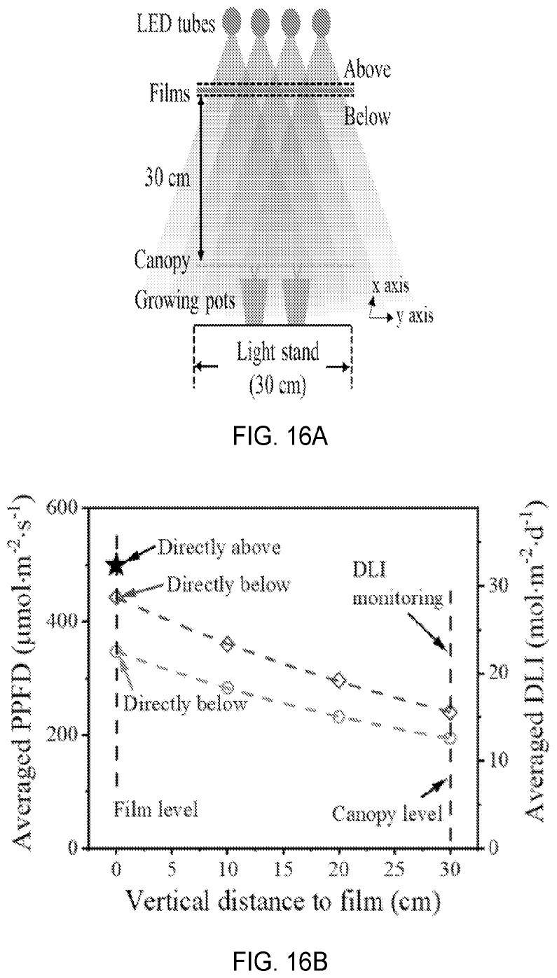

FIGS. 16A-16B illustrate light intensity distribution under LEDs employed for indoor growth. FIG. 16A schematically shows the setting on each tier of the indoor LED light stand. Throughout the growing periods, the lettuces were illuminated by three (low PAR level) and four (high PAR level) broad-spectrum LEDs light tubes with an 18:6-hour light/dark photoperiod, and there were three experimental replications in time for low and high PAR levels, respectively. The PPFDs were 350 μmol·m⁻²·s⁻¹ and 500 μmol·m⁻²·s⁻¹ for low and high PAR levels, respectively. These impinging PPFDs were measured at the position of the films (FIG. 16A), i.e., directly above the films. They were acquired by multiple measurements using a PAR quantum meter (MQ-501, Apogee Instruments, Inc., USA) at the height of directly above the films.

Due to the finite size of the light source, the intensity of light decreased as the distance from the light source increased, but the uniformity improved. In FIG. 16B, the averaged PPFD (within the light stand) is shown as a function of the distance from the films for both the fluorophore-free film and the spectral-shifting, unidirectional light-extracting film. Light intensity decayed along the vertical direction under both films. The PPFD directly above the films is also shown for comparison. For an impinging PPFD of 500 μmol·m⁻²·s⁻¹, the PPFDs were approximately 240 μmol·m⁻²·s⁻¹ and 194 μmol·m⁻²·s⁻¹ at the canopy level under the control and experimental films, respectively. Given a photoperiod of 18 hours each day, the DLIs delivered to lettuce plants (measured at the canopy level, 30 cm below the films) were approximately 15.5 mol, m⁻²·d⁻¹ and 12.5 mol·m⁻²·d⁻¹ under the control and experimental films, respectively.

The light distributions at different heights from the canopy to the films under the control and the experimental films were examined (data not shown). The light intensity was more uniform along the x-direction, i.e. the LED tube direction. Along the y-direction, the light distribution was less uniform. However, as the distance between the films and the plant canopy increased, the light distribution became increasingly more uniform. In addition, the spectral distribution was characterized at different locations with spectroscopic integrating spheres. The spectral distributions were found to be much more uniform than the intensity distributions. These measurements were conducted for high DLI treatment, with four LED tubes. The light distributions for the low DLI level with three LED tubes are similar. In Table 2, the averaged PFDs per waveband at different positions are summarized.

TABLE 2
Photon flux density (PFD) of different wavebands at different heights.

| | | Blue | Green | Red | PAR | Far red |
|---|---|---|---|---|---|---|
| | | (400-500 nm) | (500-600 nm) | (600-700 nm) | (400-700 nm) | (700-800 nm) |
| | | (μmol · | (μmol · | (μmol · | (μmol · | (μmol · |
| | | m⁻² · s⁻¹) | m⁻² · s⁻¹) | m⁻² · s⁻¹) | m⁻² · s⁻¹) | m⁻² · s⁻¹) |
| Directly above film | | 82 | 190 | 228 | 500 | 30 |
| Fluorophore-free film | Directly below | 73 | 168 | 202 | 443 | 26 |
| | 20 cm above canopy | 59 | 137 | 164 | 360 | 21 |
| | Canopy level | 39 | 92 | 109 | 240 | 14 |
| Unidirectional light- | Directly below | 40 | 46 | 261 | 347 | 30 |
| extracting film | 20 cm above canopy | 33 | 38 | 212 | 283 | 24 |
| | Canopy level | 22 | 26 | 146 | 194 | 16 |

Detailed information regarding the growing conditions of all independent replications of the indoor grown ‘Buttercrunch’ lettuces under both high and low PAR levels are listed in Table 3.

TABLE 3
Summary of indoor growth conditions.*

| | | | | | Impinging PPFD | | |
|---|---|---|---|---|---|---|---|
| | | | | | above films | DLI at canopy | |
| | | | Seedling | | (μmol · | level (mol · | Temperature |
| Treatment and replication | | | period | Growth period | m⁻² · s⁻¹) | m⁻² · d⁻¹) | (° C.) |
| Low | Rep. 1 | Control | Dec. 03-13 | Dec. 13-Jan. 05 | 350.3 ± 4.6 | 12.5 ± 0.4 | 22.0 ± 0.9 |
| PAR | | Experiment | | | 347.2 ± 7.7 | 10.2 ± 0.2 | 21.4 ± 0.8 |
| level | Rep. 2 | Control | Dec. 04-14 | Dec. 14-Jan. 06 | 351.9 ± 10.8 | 11.9 ± 0.2 | 21.8 ± 1.1 |
| | | Experiment | | | 348.8 ± 6.2 | 10.0 ± 0.2 | 21.5 ± 1.0 |
| | Rep. 3 | Control | Dec. 05-15 | Dec. 15-Jan. 07 | 347.2 ± 7.7 | 12.1 ± 0.4 | 22.0 ± 1.1 |
| | | Experiment | | | 348.8 ± 13.9 | 10.0 ± 0.2 | 22.0 ± 1.0 |
| High | Rep. 1 | Control | Dec. 08-18 | Dec. 18-Jan. 10 | 500.0 ± 13.5 | 15.8 ± 0.9 | 22.4 ± 0.9 |
| PAR | | Experiment | | | 501.5 ± 18.5 | 12.4 ± 0.7 | 22.1 ± 0.8 |
| level | Rep. 2 | Control | Dec. 09-19 | Dec. 19-Jan. 11 | 500.0 ± 12.3 | 15.5 ± 0.9 | 22.4 ± 0.8 |
| | | Experiment | | | 496.9 ± 15.4 | 12.2 ± 0.7 | 21.6 ± 0.8 |
| | Rep. 3 | Control | Dec. 11-21 | Dec. 21-Jan. 13 | 501.5 ± 12.3 | 15.5 ± 0.8 | 21.9 ± 1.1 |
| | | Experiment | | | 503.1 ± 13.9 | 12.3 ± 0.5 | 21.8 ± 1.2 |

*Photoperiod for all experiments is 18 hours

### Data Analysis and Statistical Datasets of Indoor ‘Buttercrunch’ Lettuce Growth

Plants were excised at the substrate surface and aboveground biomass was measured with an analytical balance for both the fresh weight and dry weight. To measure the dry weight, the plants were kept in a vacuum oven at 60° C. for 72 hours. Before the dry weight measurement, leaf length, width, and area of the most mature true leaf were measured using a portable laser area meter (CI-202, CID Inc., USA). Relative chlorophyll content of green leaf plants was measured by a Soil Plant Analysis Development (SPAD) chlorophyll meter (atLEAF CHL STD sensor, FT Green LLC, Wilmington, DE) while leaves were fresh. Three recently matured leaves, outside leaf midribs, veins, and margins, from each plant at three randomly selected pots were used for the measurement.

Statistical significance was determined by unpaired Student's t-test or one-way ANOVA at P<0.05. Data are reported as means±SD of 20 observations. In addition to the aboveground fresh and dry weight: leaf area and SPAD value, the leaf number, length, and width; and plant diameter at day 23 after transplant were analyzed for each replication at both high and low PAR levels. It was observed that plants under the unidirectional light-extracting film had a relatively large diameter compared to the control. In addition, the plant leaves under the experimental film were longer and wider than those under the control film and thus, had larger leaf areas (FIG. 2D). The plants under high PAR level also showed a more compact plant morphology. Moreover, statistically significant differences (other than replication 2 at low PAR level) in the relative chlorophyll content were not observed, as shown by the SPAD values in FIG. 2E.

Considering the statistical differences and potential interactions between and even within the replications, the Tukey's honestly significant test at P<0.05 was also performed with a mixed model using SAS software (ver. 9.4: SAS Institute, Inc., Cary, NC). For each PAR level, data were pooled among replications to provide a pairwise comparison between the control and experimental film treatments. The main conclusions remain the same as the Student's t-test but with elevated P-values (<0.05) due to interactions. All raw data of the six replications of the indoor growth at two different PAR levels are found in reference 33, supplemental information which is incorporated by reference herein for all purposes. The boxplots and distributions of all experimental data for three independent replications of lettuce grown under low PAR (an impinging PPFD of 350 μmol·m⁻²·s⁻¹) and a higher PAR (an impinging PPFD of 500 μmol·m⁻²·s⁻¹), respectively are found in reference 33, supplemental information. These data are incorporated by reference herein for all purposes. The analysis therein includes the leaf number, length, width, and area; plant diameter; relative leaf chlorophyll content [as measured by a Soil Plant Analysis Development (SPAD) meter]; and aboveground fresh and dry weight of lettuce at day 23 after transplant. Detailed growing conditions are shown in Table 3.

### Spectroscopic Characterizations of Lettuce Leaves

All absorbance spectra of lettuce leaves were measured immediately after the leaflets were removed from the plant (leaf color changes slightly overtime after being removed from the plant) using a UV-VIS-NIR spectrophotometer (UV-3101PC, Shimadzu Inc.) with an integrating sphere (ISR-603, Shimadzu Inc.). The leaves were clamped to the input port of the integrating sphere with the front (adaxial) side facing towards the light source for transmission measurement and the leaves were clamped to the bottom port of the integrating sphere with the front (adaxial) side facing towards the integrating sphere for reflection measurement. In all measurements, the leaves were illuminated from the front (adaxial) side. Transmission and reflection spectra of a newly picked, young leaf from a 10-day-old lettuce plant were measured and absorption spectrum was extracted from the reflection and transmission spectra, i.e., absorption=100%−reflection−transmission. The absorbance was derived from the absorption spectrum.

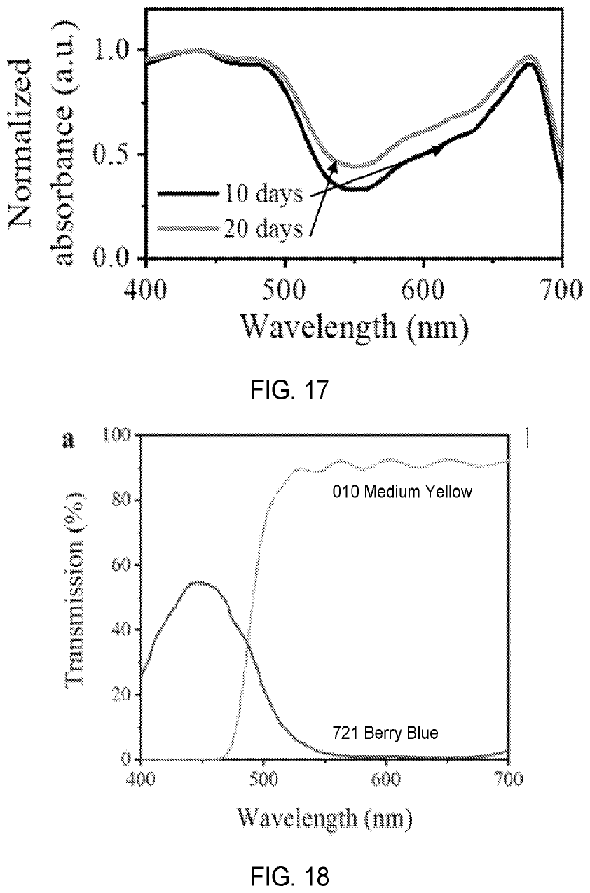

Light absorption of the lettuce leaves does vary between and even within the plants. The leaf color can also be different for different leaves within a single plant and it also can change at different stages of development. However, when light absorption data are normalized, they show similar relative absorbance differences between green and red wavebands. Different leaves show different levels of absorbance. Generally, the larger the size of a leaf, which was developed at an earlier stage, the higher the observed overall absorbance. These larger sized leaves show a relatively darker green color while the newly developed, smaller-sized leaves show a lighter green color. When all these spectra were normalized apart from the waveband of green, the absorbance profiles vary only slightly with the leaf sizes. In FIG. 17, the average absorbance spectra for a 20-day-old lettuce is compared to that for a 10-day old lettuce plant. Slight differences can be observed for the two plants at different stages of development: however, the main features of the normalized spectra are similar. The average of these normalized spectra, obtained from different leaves of the same lettuce, allows us to qualitatively assess the relative absorbance differences for different wavelengths.

### Example 6: Photosynthesis of a Whole Lettuce Plant

### Carbon Fixation of a Whole Lettuce Plant

The augmented photosynthesis and the uptake of carbon dioxide (CO₂) of a whole lettuce plant were further examined in a closed chamber (43) using a cavity-enhanced infrared gas analyzer (M-GGA-918, Los Gatos Research, USA) with a precision better than 0.4 parts per million (<0.4 ppm) at a sampling rate of 2 Hz. A pump in the analyzer circulates air in the chamber at a flowing rate of ˜0.6 L/min. The closed chamber method is one of the most widely used approaches to measuring the CO₂ efflux for low-stature canopies from bare soil surfaces (44). The closed chamber is simply a large Threshold™ glass canister illuminated using a broad-spectrum LED (High CRI 95, Active Grow Inc., Seattle, WA). The chamber had an illumination area of ˜180 cm² and an internal headspace volume of ˜4 L. Two different films including the fluorophore-free film and the unidirectional light extracting films were sequentially placed on top of the chamber for comparison. A 14-day-old ‘Buttercrunch’ lettuce plant was transplanted for the experiment. Once the chamber was closed, the lettuce went through multiple experimental cycles. Each cycle was comprised of ˜300 sec in darkness (for respiration) and ˜300 sec under the illumination of the broad-spectrum LEDs (for photosynthesis) (FIG. 14). Two different films including the fluorophore-free film (control) and the unidirectional light-extracting films (experiment) were sequentially introduced on top of the chamber before the light was turned on. To compare the CO₂ uptake kinetics by the whole lettuce under the unidirectional light-extracting and the control films, a single exponential model (45) was fitted to the changes of the CO₂ concentration in the closed chamber.

In the closed chamber, the time variation of CO₂ concentration, dc/dt, is mainly affected by:
(1) photosynthesis of the plant,

$${( \frac{dc}{dt} )}_{P}$$

when the light is on,
(2) respiration of the plant

$${( \frac{dc}{dt} )}_{R}$$

when the light is off, and
(3) diffusion from the soil,

$${( \frac{dc}{dt} )}_{S} , i . e . , \frac{dc}{dt} = {( \frac{dc}{dt} )}_{P} + {( \frac{dc}{dt} )}_{R} + {( \frac{dc}{dt} )}_{S} .$$

The CO₂ efflux from the soil to the overlying air takes place mainly due to the respiration of soil microbes, soil animals, and belowground biomass of plants including roots and rhizomes (43). Inside the headspace of the closed chamber, CO₂ is removed via photosynthesis (when the light is on) and supplied by plants' respiration (when the light is off).

The time-dependent photosynthesis and respiration are approximated as single-exponential functions (45),

$${( \frac{dc}{dt} )}_{R} = + {A}_{R} {e}^{- t / {τ}_{R}} ,$$

when light is off

$${( \frac{dc}{dt} )}_{P}^{C} = - {A}_{P}^{C} {e}^{- t / {τ}_{P}^{C}} ,$$

when light is on and the control film is used

$${( \frac{dc}{dt} )}_{P}^{E} = - {A}_{P}^{E} {e}^{- t / {τ}_{P}^{E}} ,$$

when light is on and the experimental film is used

$${( \frac{dc}{dt} )}_{S} = + {A}_{S} {e}^{- t / {τ}_{S}} ,$$

when the chamber is closed
Here τ_{P}^{C}, and τ_{P}^{E} are the time constants that depict the response of the CO₂ concentration inside the closed chamber as a result of photosynthesis (when light is on) under the fluorophore-free films and the spectral-shifting, unidirectional light-extracting films, respectively. τ_{R} and τ_{S} are the time constants that describe the response of CO₂ concentration due to respiration (when light is off) and soil diffusion. Table 4 summarized the fitted time constants. The time constant under the spectral-shifting film, τ_{P}^{E}, is ˜24% smaller than that under the control film, τ_{P}^{C}, indicating a substantially increased photosynthesis rate as a result of spectral conversion and unidirectional light extraction.

TABLE 4
The results of time constants fitted by single-exponential functions.

| | | Confidence level (95%) |
|---|---|---|
| Time Constants (sec) | | (lower limit; upper limit) |
| τ_{P}^{C} | 1818 | (1667; 2000) |
| τ_{P}^{E} | 1389 | (1299; 1493) |
| τ_{R} | 1075 | (1042; 1111) |
| τ_{S} | 370 | (357; 385) |

Here it is assumed that the soil temperature, headspace air temperature, and pressure are constant and approximately the same as ambient conditions. Changes in light, temperature, and humidity would change plant physiology and thus complicate the CO₂ variations in the closed chamber. The closed-chamber method is known to have a number of drawbacks including temperature changes of the soil and the chamber air, disturbance of pressure across the soil-atmosphere interface, potential leakages directly within the chamber components or via the underlying soil pore space, among others (43).

### Example 7: Impact of Blue Light Reductions on Indoor ‘Buttercrunch’ Lettuce Growth

The spectral-shifting, unidirectional light-extracting film attenuates nearly 45% of the blue light (400-500 nm) due to the non-negligible absorption of the fluorophores used (LF305). Blue light does play an important role in plant development. It often influences plant morphology (including chlorophyll density and extension growth), biosynthesis of secondary metabolites, and ultimately, biomass production. It is known that excessive blue light can, in certain cases, indirectly suppress growth by inhibiting extension growth and thus, radiation capture. Blue light can suppress the extension of some types of leafy green cultivars, e.g., “Rouxai” lettuce (46). Substituting blue light with other wavebands such as green or far-red light can induce shade avoidance and indirectly promote growth (46). However, the impact of blue light is sensitive to its intensity and is modulated by other spectral components of photosynthetically active light (47-49).

To understand the role of the reduced blue irradiation under the spectral-shifting, unidirectional light-extracting film, a set of indoor growth experiments were designed. In these experiments, the PFD of the blue waveband (400-500 nm) was tailored either by a sheet of a polymeric long-pass filter with a cut-off wavelength at 492 nm (010 Medium Yellow; LEE Filters, CA, USA) or by a polymeric band-pass filter with a long wavelength cut-off at 495 nm (721 Berry Blue, LEE Filters, CA, USA). The transmission spectra of the filters are shown in FIG. 18. The long-pass filter eliminated the majority of blue light with wavelengths shorter than 492 nm and transmitted more than 90% of the green (500-600 nm) and red (600-700 nm) light. In contrast, the band-pass filter transmitted blue light with wavelengths shorter than 495 nm with an average transmission near 50% between 430 nm and 470 nm. Three white light LED tubes (High CRI 95, Active Grow Inc., Seattle, WA) were wrapped with LEE filters. When the light tubes were fully wrapped with the blue band-pass filter, these tubes provided almost solely blue light; when the light tubes were partially wrapped with the yellow long-pass filter, these light tubes supplied yellow light with attenuated blue light: finally, when the tubes were fully wrapped with the yellow long-pass filter, these tubes provided practically no blue light.

To examine the impact of blue light, a comparison experiment was first conducted by supplying different amounts of blue light. The treatments included the growth of ‘Buttercrunch’ lettuce under: 1) a spectral-shifting, unidirectional light-extracting film with nearly no (w/o) blue light (by fully wrapping the LED tubes with the yellow LEE long-pass filter, 2) a spectral-shifting, unidirectional light-extracting film with reduced (−) blue light (by wrapping partially the LED tubes with the yellow LEE long-pass filter), 3) a spectral-shifting, unidirectional light-extracting film, and 4) a spectral-shifting, unidirectional light-extracting film with supplementary (+) blue light (by introducing two additional LED tubes below the experimental film that were fully wrapped with the blue LEE band-pass filters). The experiments were carried out in a temperature-controlled walk-in growing compartment. Ten days after germination, seedlings of ‘Buttercrunch’ lettuce were transplanted and grown under these treatments. The sowing and watering processes were identical to other indoor growth experiments. Each treatment had 20 lettuce plants grown in pots under long-day conditions with an 18:6-hour light/dark photoperiod at an average ambient temperature of 20° C. Light curtains were used between the light stands to avoid light contamination between treatments.

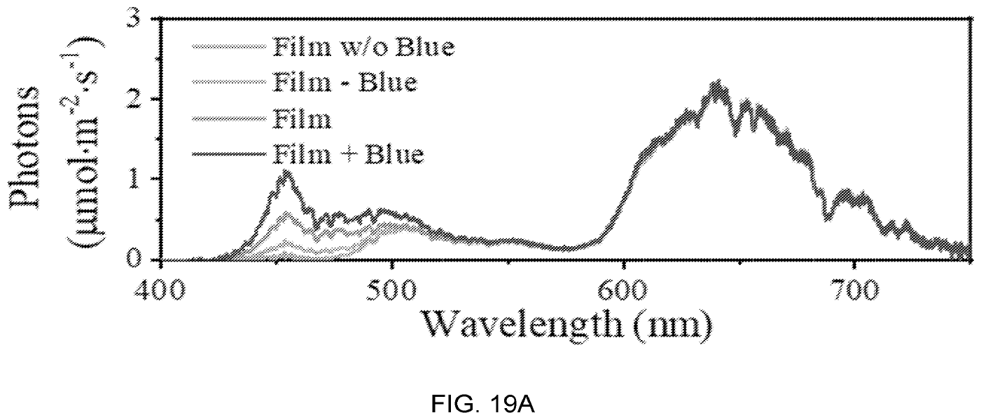

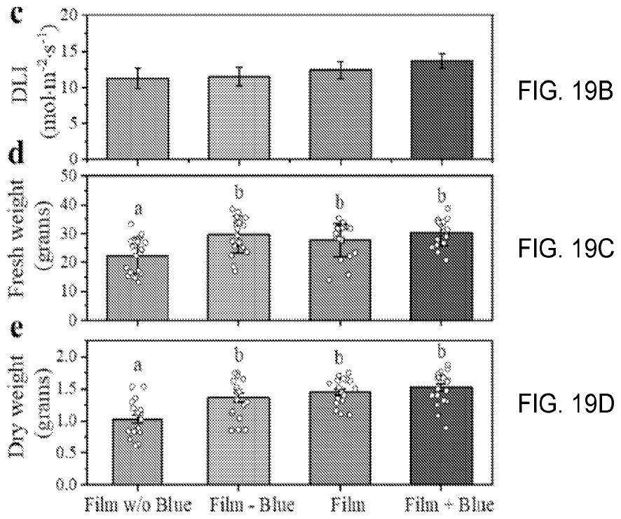

FIG. 19A shows the averaged spectral distributions at the canopy level for the different treatments. The LEE filters changed the PFD in the blue waveband and showed negligible changes in the green, red, and far red wavebands. A quantitative analysis of the PFDs in each waveband is provided in Table 5. Under the spectral-shifting, unidirectional light-extracting film, the blue PFD (400 nm-500 nm) was 22 μmol·m⁻²·s⁻¹. It increased to 38 μmol m⁻²·s⁻¹ by supplementing (+) blue light and decreased to 10 μmol·m⁻²·s⁻¹ when the LED tubes were partially wrapped with the LEE long-pass filters (−). The blue PFD under the unidirectional light-extracting film was further attenuated when the LED tubes were fully wrapped with the LEE long-pass filters, with merely 5 μmol·m⁻²·s⁻¹ blue PFD left.

FIG. 19B shows the average daily light integral (DLI) measured at the canopy level for the four experimental replicates. The DLI was averaged at different locations at canopy height using a PAR quantum meter (MQ-501, Apogee Instruments, Inc., USA). The average DLI (Table 5) shows ˜7% and ˜9% reduction when the LED tubes were partially and fully wrapped by the yellow LEE long-pass filter and a ˜10% increase with the supplementary blue light when compared to that under the spectral-shifting, unidirectional light-extracting film, corresponding to ˜55% and ˜77% reduction and a ˜73% increase in the blue PFD.

FIGS. 19C and 19D show the aboveground fresh weight and dry weight, respectively, of the lettuces at day 16 after transplantation for the treatments with four different levels of blue light. There was no significant difference observed in the aboveground fresh or dry weight except with nearly complete removal of blue PFD. The variations in the blue PFD (from 10 to 38 μmol·m⁻²·s⁻¹) intercepted by lettuce plants clearly did not change their aboveground growth. Similar results were also observed by Namnin et al. (50).

While no statistical differences were found in the aboveground biomass as the blue PFD varied from 10 to 38 μmol·m⁻²·s⁻¹, as previously reported by other authors before (46-48), the lettuce plants showed somewhat elongated leaves and a less compact leaf arrangement at a decreased blue PFD. In contrast, lettuce grown with more blue light tends to be more compact. However, quantitative analysis of the other lettuce plant characteristics including leaf number, length, width, and area indicated no statistical differences between different experiments (data not shown). The lettuce plants showed a significantly larger diameter when the blue PFD was less than 22 μmol·m⁻²·s⁻¹. Also lettuce leaves grown under the film with reduced blue light showed statistically lower SPAD values compared to the others, which is an indicator of decreased chlorophyll density and leaf greenness. All raw data of the indoor growth under the spectral-shifting, light-extracting film with tailored blue light provided in reference 33, supplemental information. This data is incorporated by reference herein for all purposes.

The reduction of blue light makes the ‘Buttercrunch’ lettuce more extended in morphology which can potentially increase above-ground biomass production. However, the comparison experiment indicated that the reduction of blue PFD from 38 to 10 μmol·m⁻²·s⁻¹ did not enhance the above-ground biomass of the lettuce plants. No statistically significant effect on biomass accumulation was observed until the nearly complete removal of blue PFD. The amount of blue light did influence the chlorophyll concentration (as assessed by SPAD) in leaves. The growth morphology might also be ascribed to a synergetic effect of red, far red, and blue radiation as an increased red to far red ratio (which is the case underneath the LF305-doped unidirectional light-extracting film as shown in Table 5) can also potentially increase the phytochrome photoequilibrium and suppress the extension growth (47).

### Statistical Datasets of ‘Buttercrunch’ Lettuce Growth in a Research Greenhouse

Analysis of the statistics for the morphologies of lettuce grown in the greenhouse show an increase in leaf number and length, and plant diameter. All raw data of the greenhouse environments are provided in provided in reference 33, supplemental information. This data is incorporated by reference herein for all purposes.

TABLE S
DLI and spectral distributions in different wavebands at canopy levels under the spectral-
shifting, unidirectional light-extracting film with four different levels of blue light.

| | Blue | Green | Red | | | PAR | DLI | Far Red |
|---|---|---|---|---|---|---|---|---|
| | 400-500 nm | 500-600 nm | 600-700 nm | R:G | R:B | 400-700 nm | 400-700 nm | 700-750 nm |
| | (μmol m⁻² s⁻¹) | (μmol m⁻² s⁻¹) | (μmol m⁻² s⁻¹) | ratio | ratio | (μmol m⁻² s⁻¹) | (mol m⁻² d⁻¹) | (μmol m⁻² s⁻¹) |
| Film w/o Blue | 5 | 25 | 145 | 5.8 | 29.0 | 175 | 11.3 | 17 |
| Film − Blue | 10 | 25 | 143 | 5.7 | 14.3 | 178 | 11.5 | 16 |
| Film | 22 | 26 | 144 | 5.6 | 6.6 | 192 | 12.4 | 16 |
| Film + Blue | 38 | 29 | 144 | 5.0 | 3.8 | 211 | 13.7 | 17 |

### Example 8: Outdoor ‘Buttercrunch’ Lettuce Growth with Sunlight

### Lettuce Growth in a Research Greenhouse

Four semi-cylindrical roof domes (0.5 m in height and 1.5 m in length) were constructed. Two domes had spectral-shifting, unidirectional light-extracting films installed (experiment) while the two others had fluorophore-free films (control). Comparative growth studies of the ‘Buttercrunch’ lettuce were performed under natural sunlight in the Plant Science Research Greenhouse facility at Michigan State University (East Lansing, MI, USA). The glass-glazed greenhouse temperature was maintained by a greenhouse environmental control system (Integro 725; Priva North America, Vineland, Ontario, Canada), which controlled roof vents and exhaust fans. The temperature in each dome was monitored by a shielded and aspirated thermocouple (Type E; Omega Engineering, Inc., Stamford, CT, UST) (see the appended growth log file, Data SI “Growth Data Log-Greenhouse”). The real-time PPFD at the canopy level was monitored by a PAR quantum meter (LI-190SA; LI-COR, Inc., Lincoln, NE, USA). The same sowing process was applied (see “Indoor growth of ‘Buttercrunch’ lettuce”), and the seedlings of lettuce were transplanted 10 days after germination into 0.8 L pots (Landmark Plastics, Akron, OH) containing a peat-based substrate (Black Gold, Agawam, MA). Watering was provided as needed (every 2 to 3 days) with reverse-osmosis water supplemented with a water-soluble fertilizer (see “Indoor growth of ‘Buttercrunch’ lettuce”). Two independent replications of lettuces were carried out in parallel. In each replication, the fluorophore-free film with structures (control) and light-extracting film (experiment) was tested, and each replication was comprised of 10 lettuce plants under the control film and 10 plants under the experimental film. These plants were randomized and equally distributed to four domes. Domes of control and experiment replications were in an alternative arrangement to reduce environmental variation, such as in ambient temperature and airspeed.

‘Buttercrunch’ lettuce growth was compared under nearly identical semi-cylindrical domes with the fluorophore-free film (control) and the spectral-shifting, unidirectional light-extracting film (experiment) in an outdoor open environment. The semi-cylindrical domes with different films were placed in a staggered arrangement.

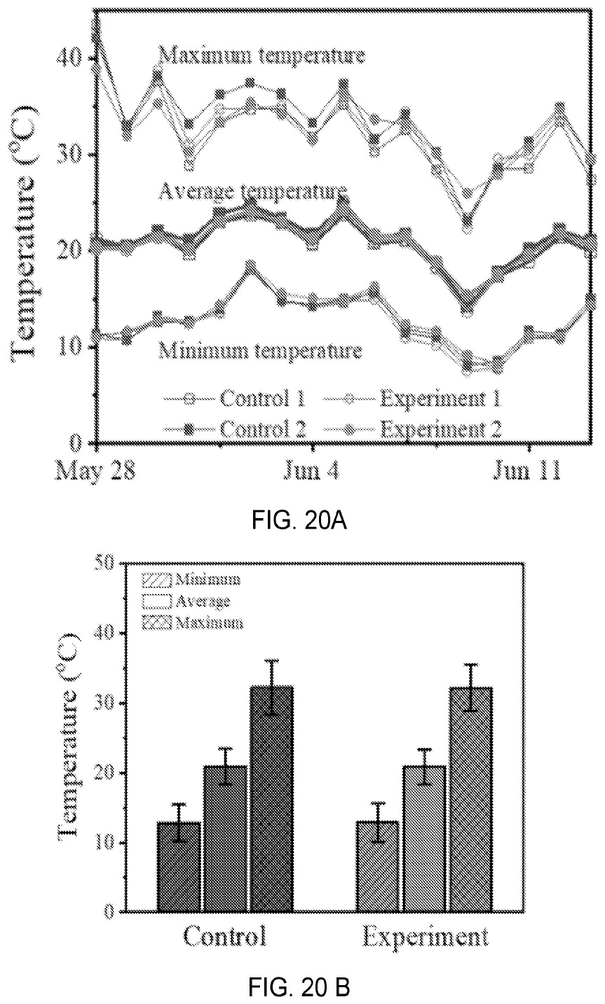

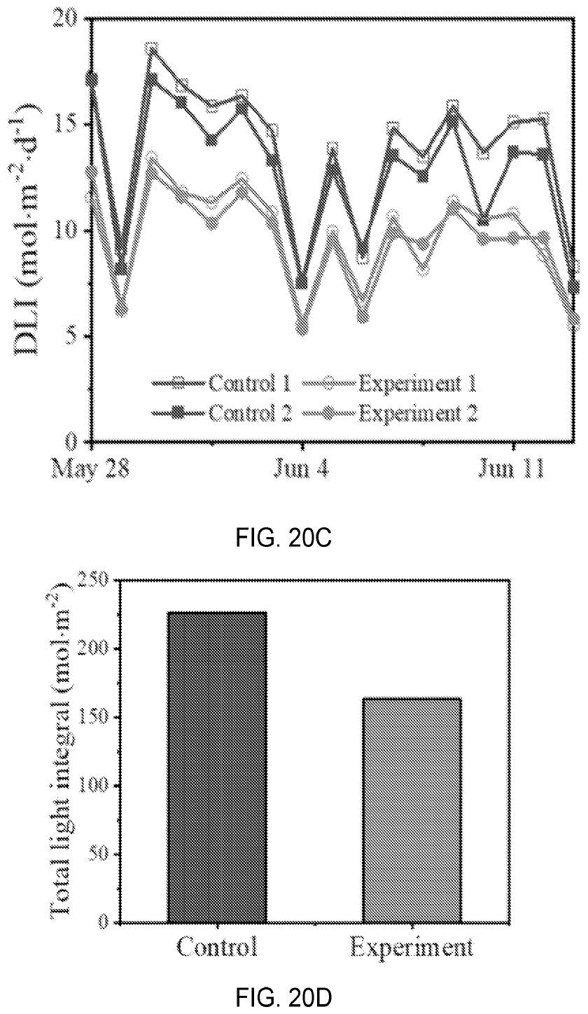

The temperature inside each dome was monitored by an ambient weather remote thermometer (WS-3000-X5, Chandler, AZ, USA), covered by aluminum foil to reduce direct exposure to sunlight. The PPFD at the canopy level was measured by a PAR quantum meter (MQ-520, Apogee Instruments, Inc., USA). Similar to the greenhouse experiment, the daily temperature distribution under the four domes was similar (FIG. 20A). The average temperature during the entire growing period (FIG. 20B) under the control and the experimental domes was 20.9° C. and 20.8° C., respectively. To avoid overheating during the summertime, 50% shade cloths (or occasionally a 70% shade cloth and a rain curtain) were introduced as needed to decrease solar irradiance and thus the temperature inside. FIG. 20C shows the DLI under each dome, which also varied significantly with the weather conditions. The average DLI under the experimental dome was 9.6 mol·m⁻²·d⁻¹, which was 28% lower than that under the control dome. The total light integral (FIG. 20D) during the growth period (17 days) was 226 mol·m⁻² and 163 mol·m⁻², respectively. The unidirectional light-extracting film significantly increased the aboveground fresh weight and dry weight of lettuce at day 17 after transplantation by as much as 16.5% and 15.8%, respectively. Increases in leaf number and length, and plant diameter were also observed. The light-extracting film did not alter the relative leaf chlorophyll concentration. Data for aboveground fresh weight, dry weight, leaf number, leaf length, width and area, plant diameter and SPAD are provided in reference 33. All raw data of the outdoor growth are provided in reference 33, and are incorporated by reference herein for all purposes.

TABLE 6
Comparison of ‘Buttercrunch’ Lettuce Growth

| | Indoors (High PAR level) | | Greenhouse | | Outdoors | |
|---|---|---|---|---|---|---|
| | Dec. 18-Jan. 10 | | July 25 to Aug. 13 | | May 28-June 13 | |
| | Control | Experiment | Control | Experiment | Control | Experiment |
| Average DLI (mol m⁻² d⁻¹) | 15.6 | 12.3 | 15.1 | 11.1 | 13.3 | 9.6 |
| Total light integral (mol m⁻²) | 359 | 283 | 302 | 222 | 226 | 163 |
| Fresh Weight (g) | 38.5 | 47.0 | 42.4 | 51.6 | 12.7 | 14.8 |
| Fresh Weight Relative enhancement (%) | — | 22.2 | — | 21.7 | — | 16.5 |
| Fresh Weight per mole of light | 107.3 | 166.1 | 140.4 | 232.4 | 56.2 | 90.7 |
| (mg/(mol m⁻²) | | | | | | |
| Fresh Weight per mole of light | — | 54.8 | — | 65.6 | — | 61.4 |
| Relative enhancement (%) | | | | | | |

The indoor compartment had a well-regulated environment and electric lighting. The research greenhouse had a partially regulated environment. The outdoor open space had an unregulated environment with natural sunlight.

### Example 9: Comparison of Indoor, Greenhouse and Outdoor ‘Buttercrunch’ Lettuce Growths

Table 6 summarizes and compares the yield enhancements that were achieved in the indoor growth compartment with a well-regulated environment using electric lighting, in a research greenhouse with a partially regulated environment and natural sunlight, and in an outdoor open space with an unregulated environment with natural sunlight. In all experiments, consistent augmentations in crop yield were observed. Under the unidirectional light-extracting film (experiment), the above-ground fresh weight increased nearly 20% when compared to that of the controls, although the average DLI under the experimental film was ˜ 20% lower than that of the control. When comparing the radiation use, the fresh weight increased by 55 to 66% per mole of light per square meter, demonstrating the quality of photosynthetic light plays a key role and can substantially improve the yield with no additional energy inputs.

### REFERENCES

1. Z. Johnson, R. T. Barber, The low-light reduction in the quantum yield of photosynthesis: Potential errors and bias when calculating the maximum quantum yield. Photosynth Res 75, 85-95 (2003). doi: 10.1023/A:1022440305765: pmid: 16245096
2. M. D. Ooms, C. T. Dinh, E. H. Sargent, D. Sinton, Photon management for augmented photosynthesis. Nature communications 7, 12699 (2016). doi: 10.1038/ncomms12699: pmid: 27581187
3. M. Zhang, C. M. Whitman, E. S. Runkle, E. S. Manipulating growth, color, and taste attributes of fresh cut lettuce by greenhouse supplemental lighting. Scientia Hort. 252, 274-282 (2019). doi: 10.1016/j.scienta.2019.03.051
4. P. Pinho, K. Jokinen, L. Halonen, Horticultural lighting-present and future challenges. Light. Res. Technol. 44, 427-437 (2012). doi: 10.1177/1477153511424986.
5. K. Stober, K. Lee, M. Yamada, M. Pattison, Energy savings potential of SSL in horticultural applications. U.S. Department of Energy, Washington, DC, USA (2017). doi: 10.2172/1418429.
6. K. J. McCree, The action spectrum, absorptance and quantum yield of photosynthesis in crop plants. Agric. Meteorol. 9, 191-216 (1972). doi: 10.1016/0002-1571(71)90022-7
7. L. Wondraczek et al., Solar spectral conversion for improving the photosynthetic activity in algae reactors. Nature communications 4, 2047 (2013). doi: 10.1038/ncomms3047; pmid: 23797513
8. S. F. Mohsenpour, B. Richards, N. Willoughby, Spectral conversion of light for enhanced microalgae growth rates and photosynthetic pigment production. Bioresour. Technol. 125, 75-81 (2012). doi: 10.1016/j.biortech.2012.08.072: pmid: 23023239
9. A. M. Detweiler et al., Evaluation of wavelength selective photovoltaic panels on microalgae growth and photosynthetic efficiency. Algal research 9, 170-177 (2015). doi: 10.1016/j.algal.2015.03.003
10. S. El-Bashir, F. Al-Harbi H. Elburaih, F. Al-Faifi, I. Yahia, Red photoluminescent PMMA nanohybrid films for modifying the spectral distribution of solar radiation inside greenhouses. Renewable Energy 85, 928-938 (2016). doi: 10.1016/j.renene.2015.07.031
11. M. E. Loik et al., Wavelength-Selective Solar Photovoltaic Systems: Powering Greenhouses for Plant Growth at the Food-Energy-Water Nexus. Earth's Future 5, 1044-1053 (2017). doi: 10.1002/2016EF000531
12. P. Campbell, M. A. Green, Light trapping properties of pyramidally textured surfaces. Journal of Applied Physics 62, 243-249 (1987). doi: 10.1364/OL.35.000106: pmid: 20081936
13. H. A. Atwater, A. Polman, Plasmonics for improved photovoltaic devices. Nature materials 9, 205 (2010). doi: 10.1038/nmat2629; pmid: 20168344
14. F. Meinardi, F. Bruni, S. Brovelli, Luminescent solar concentrators for building-integrated photovoltaics. Nature Reviews Materials 2, 17072 (2017). doi: 10.1038/natrevmats.2017.72
15. A. I. Zhmakin, Enhancement of light extraction from light emitting diodes. Phys. Rep. 498, 189-241 (2011). doi: 10.1016/j.physrep.2010.11.001
16. Q. Zhang, et al., Light Out-Coupling Management in Perovskite LEDs-What Can We Learn from the Past? Adv. Funct. Mater. 2002570 (2020). doi: 10.1002/adfm.202002570
17. I. Schnitzer, E. Yablonovitch, C. Caneau, T. Gmitter, A. Scherer, 30% external quantum efficiency from surface textured, thin-film light-emitting diodes. Applied Physics Letters 63, 2174-2176 (1993). doi: https://doi.org/10.1063/1.110575
18. R. Winston, J. C. Minano, P. G. Benitez, Nonimaging Optics, Academic Press: 1 edition (2005).
19. S. J. Lee, Analysis of light-emitting diode by Monte-Carlo photo simulation. Appl. Opt., 40, 1427-1437 (2001). doi: 10.1364/AO.40.001427
20. Z. Liu, K. Wang, X. Luo, S. Liu, Precise optical modeling of blue light-emitting diodes by Monte Carlo ray-tracing. Opt. Express 18, 9398-9412 (2010). doi: 10.1364/OE.18.009398
21. C. Corrado et al., Optimization of gain and energy conversion efficiency using front-facing photovoltaic cell luminescent solar concentrator design. Solar Energy Materials and Solar Cells 111, 74-81 (2013). doi: 10.1016/j.solmat.2012.12.030
22. J. Wang, W. Lu, Y. Tong, Q. Yang, Leaf morphology, photosynthetic performance, chlorophyll fluorescence, stomatal development of lettuce (Lactuca sativa L.) exposed to different ratios of red light to blue light. Front. Plant. Sci. 7, 1-10 (2016). doi: 10.3389/fpls.2016.00250
23. T. A. O. Dougher, B. Bugbee, Differences in the response of wheat, soybean and lettuce to reduced blue radiation. Photochem. Photobiol. 73, 199-207 (2001). doi: 10.1562/0031-8655(2001)0730199DITROW2.0.CO2
24. H. H. Kim, G. Goins, R. Wheeler, J. Sager, Green light supplementation for enhanced lettuce growth under red and blue light-emitting diodes. Hortscience 39, 1617-1622 (2004).
25. Y. Park, E. S. Runkle, Far-red radiation promotes growth of seedlings by increasing leaf expansion and whole-plant net assimilation. Environ. Expt. Bot. 136, 41-49 (2017).
26. G. Pennisi, et al., Resource use efficiency of indoor lettuce (Lactuca sativa L.) cultivation as affected by red:blue ratio provided by LED lighting. Sci Rep 9, 14127 (2019).
27. M. T. Naznin, M. Lefsrud, V. Gravel, M. O. K. Azad, Blue Light added with red LEDs enhance growth characteristics, pigments content, and antioxidant capacity in Lettuce, Spinach, Kale, Basil, and Sweet Pepper in a controlled environment. Plants 8(4), 93 (2019).
28. G. Griffini, M. Levi, S. Turri, Novel crosslinked host matrices based on fluorinated polymers for long-term durability in thin-film luminescent solar concentrators, Solar Energy Materials and Solar Cells, 118 36-42, (2013). doi: 10.1016/j.solmat.2013.05.041
29. C. S. Erickson et al., Zero-reabsorption doped-nanocrystal luminescent solar concentrators. ACS nano 8, 3461-3467 (2014). doi: 10.1021/nn406360w
30. T. Wang et al., Luminescent solar concentrator employing rare earth complex with zero self-absorption loss. Solar Energy 85, 2571-2579 (2011). doi: 10.1016/j.solener.2011.07.014
31. M. J. Currie, J. K. Mapel, T. D. Heidel, S. Goffri, M. A. Baldo, High-efficiency organic solar concentrators for photovoltaics. Science 321, 226-228 (2008). doi: 10.1126/science.1158342: pmid: 18621664
32. F. T. Haxo, Photosynthetic action spectra of marine algae. J. Gen. Physiol. 33, 389-422 (1950). doi: 10.1085/jgp.33.4.389.
33. L. Shen, R. Lou, Y. Park, Y. Guo, E. J. Stallknecht, Y. Xiao, D. Rieder, R. Yang, E. S. Runkle and X. Yin, Increasing greenhouse production by spectral shifting and unidirectional light-extracting photonics. Nature Food, 2:434-441 (Jun. 18, 2021) and supplemental material available on line from the publisher (Nature). doi: 10.1038/s43016-021-00307-8
34. Z. Krumer, W. G. J. H. M. van. Sark, R. E. I. Schropp, C. D. M. Donega, Compensation of self-absorption losses in luminescent solar concentrators by increasing luminophore concentration. Sol. Energy Mater. Sol. Cell. 167, 133-139 (2017). doi: 10.1016/j.solmat.2017.04.010
35. Z. Krumer, et al., Tackling self-absorption in luminescent solar concentrators with type-II colloidal quantum dots. Sol. Energ. Mater. Sol. Cell. 111, 57-65 (2013). doi: 10.1016/j.solmat.2012.12.028
36. M. H. Shin, H. J. Kim, Y. J. Kim, Optical modeling based on mean free path calculations for quantum dot phosphors applied to optoelectronic devices. Opt. Express 25, A113-A123 (2017). doi: 10.1364/OE.25.00A113
37. Y. Sun, S. R. Forrest, Organic light emitting devices with enhanced out-coupling via microlenses fabricated by imprint lithography. J. Appl. Phys. 100, 073106 (2006). doi: 10.1063/1.2356904
38. E. Hecht, Optics (Fifth edition), Pearson Education, 2015.
39. W. G. J. H. M. van Sark, et al., Luminescent Solar Concentrators—A review of recent results, Opt. Express 16, 21773-21792 (2008). doi: 10.1364/OE.16.021773
40. A. W. LaVigne., The Next Farm Bill: Technology & Innovation in Specialty Crops American Seed Trade Association 2017, Retrieved at https://www.betterseed.org/wpcontent/uploads/Andrew-LaVigne-House-Ag-testimony-7-12-17.pdf.
41. Q. Meng, W., J. Boldt, E. Runkle, Blue radiation interacts with green radiation to influence growth and predominantly controls quality attributes of lettuce, J. Amer. Soc. Hort. Sci., 1-13 (2020). doi: 10.21273/JASHS04759-19
42. P. F. South, A. P. Cavanagh, H. W. Liu, D. R. Ort, Synthetic glycolate metabolism pathways stimulate crop growth and productivity in the field. Science 363, eaat9077 (2019). doi: 10.1126/science.aat9077
43. L. Kutzbach, et al., CO2 flux determination by closed-chamber methods can be seriously biased by inappropriate application of linear regression. Biogeoscience 4, 1005-1025 (2007).
44. L. S. Jensen, et al., Soil surface CO2 flux as an index of soil respiration in situ: a comparison of two chamber methods, Soil Biol. Biochem. 28, 1297-1306 (1996).
45. M. L. Cabrera, D. E. Kissel, M. F. Vigil, Nitrogen mineralization from organic residues: research opportunities. Journal of Environmental Quality 34, 75-79 (2005).
46. Meng, N. Kelly, E. S. Runkle, Substituting green or far-red radiation for blue radiation induces shade avoidance and promotes growth in lettuce and kale. Environ. Exp. Bot. 162, 383-391 (2019).
47. E. S. Runkle, R. D. Heins, Specific Functions of Red, Far Red, and Blue Light in Flowering and Stem Extension of Long-day Plants. J. Amer. Soc. Hort. Sci. 126, 275-282 (2001).
48. K. H. Son, M. M. Oh, Leaf shape, growth, and antioxidant phenolic compounds of two lettuce cultivars grown under various combinations of blue and red light-emitting diodes. HortScience 48, 988-995 (2013).
49. W. H. Kang, J. S. Park, K. S. Park, J. E. Son. Leaf photosynthetic rate, growth, and morphology of lettuce under different fractions of red, blue, and green light from light-emitting diodes (LEDs). Hortic. Environ. Biotechnol. 57, 573-579 (2016).
50. M. T. Naznin, M. Lefsrud, V. Gravel, M. O. K. Azad, Blue Light added with red LEDs enhance growth characteristics, pigments content, and antioxidant capacity in Lettuce, Spinach, Kale, Basil, and Sweet Pepper in a controlled environment. Plants 8(4), 93 (2019).

1.-37. (canceled)

38. A spectral-shifting and unidirectional light extracting film or sheet which comprises a matrix having a spectral-shifting material or spectral-shifting compound distributed therein, the film or sheet having a top surface through which light enters and a bottom surface through which light exits, wherein the film also comprises at least one surface structure that functions for unidirectional light extraction and wherein the at least one surface structure has at least one dimension that is microscaled.

39. The film or sheet of claim 38, wherein the matrix is a polymer matrix which is substantial transparent to light wavelengths useful in a selected application.

40. The film or sheet of claim 38, wherein the matrix is a solid which is substantial transparent to light of wavelengths useful in a selected application and into which the spectral-shifting material or spectral-shifting compound is introduced and distributed.

41. The film or sheet of claim 40, wherein the solid is glass or quartz.

42. The film or sheet of claim 38, wherein the spectral-shifting material or spectral-shifting compound is or comprises a molecular dye, a quantum dot or a phosphorous compound.

43. The film or sheet of claim 38, wherein the spectral-shifting material or spectral-shifting compound is or comprises LF305, an organic phosphor or a rare earth complex.

44. The film or sheet of claim 38 which comprises two or more layers.

45. The film or sheet of claim 38 which comprises two or more layers and wherein the spectral-shifting material or spectral-shifting compound is in a layer different than the layer which comprise the surface structure or is in the same layer that comprises the surface structure.

46. The film of claim 38, wherein the film is supported on a substantially transparent substrate.

47. The film or sheet of claim 38, wherein the at least one surface structure is formed on the top surface.

48. The film or sheet of claim 38, wherein the at least one surface structure is formed on the bottom surface.

49. The film or sheet of claim 38, wherein the at least one surface structure comprises an array of microdomes, wherein a microdome has a height ranging from about 50 to about 100 microns.

50. The film or sheet of claim 38, wherein the at least one surface structure comprises an array of microdomes, wherein a microdome has a height ranging from about 50 to about 100 microns, and wherein a microdome has a period of 300 to 500 microns.

51. The film or sheet of claim 38, wherein the at least one surface structure comprises an array of microdomes which are close-packed.

52. The film or sheet of claim 38, wherein the film or sheet has a thickness ranging from 5 microns up to 10 millimeters.

53. A method for delivering a selected shifted wavelength range to a selected location from a source of illumination which comprises positioning the film or sheet of claim 38 between the source and the delivery location, such that light from the source passes through the thickness of the film or sheet and the selected shifted wavelength range is delivered to the selected location.

54. A method for enhancing the growth of a seed, seedling or plant which comprises delivery of a selected shifted wavelength range suitable for growth enhancement of the seed, seedling or plant to a location containing the seed, seedling or plant, wherein the film or sheet of claim 38 is positioned between the source of illumination and the location and where the spectral-shifting material or spectral-shifting compound is selected to provide the selected shifted wavelength range.

55. The method of claim 54, wherein the film or sheet is positioned on a greenhouse or other plant growth structure.

56. The method of claim 54, wherein the source of illumination is artificial light or natural sunlight.

57. A greenhouse wherein the film or sheet of claim 38 covers at least a portion of the windows in the greenhouse.
